(19) United States
(12) Patent Application Publication
(10) Pub. No.: US 2017/0337498 A1
(43) Pub. Date: Nov. 23, 2017

(54) PREDICTIVE ANALYTICS SOLUTION SUPPORT METHOD AND SYSTEM

(71) Applicant: R&B Soft, LLC, Carbondale, IL (US)

(72) Inventors: Shahram Rahimi, Carbondale, IL (US); Shahriar Bozorgzadeh, Bellingham, WA (US); Zahra Eftekhari, Pasadena, CA (US)

(73) Assignee: R&B Soft, LLC, Carbondale, IL (US)

(21) Appl. No.: 15/159,310

(22) Filed: May 19, 2016

(51) Int. Cl. G06Q 10/06

(52) U.S. Cl. CPC G06Q 10/06375; G06Q 10/0635

(57) ABSTRACT

A method for using predictive analytics to support decision-making on an issue, including steps of: identifying a plurality of players involved in the issue; determining, for each of the plurality of players, a priority of the issue for each player, a power of each player to influence the issue, and a position of each player with regard to the issue; simulating a plurality of rounds of negotiation between each of the plurality of players, wherein each round includes steps of calculating a median voter position, calculating an expected utility for each of the plurality of players, each of the plurality of players receiving a plurality of offers from at least one other player, each of the plurality of players accepting one of the plurality of offers, and updating power and position for each of the plurality of players; and identifying a consensus position and ending the simulation if none of the plurality of players receives an offer.

### FIELD OF THE INVENTION

The present invention relates to predictive analytics.

### INTRODUCTION

Decision-making in many areas is the most important factor responsible in making huge profit or loss or, in the field of international relations, can determine whether a party achieves a satisfactory outcome in a conflict. Thus there is an interest in providing tools to facilitate decision-making.

### SUMMARY OF THE INVENTION

In one aspect, a method for using predictive analytics to support decision-making on an issue, including steps of: identifying a plurality of players involved in the issue; determining, for each of the plurality of players, a priority of the issue for each player, a power of each player to influence the issue, and a position of each player with regard to the issue; simulating a plurality of rounds of negotiation between each of the plurality of players, wherein each round includes steps of calculating a median voter position, calculating an expected utility for each of the plurality of players, each of the plurality of players receiving a plurality of offers from at least one other player, each of the plurality of players accepting one of the plurality of offers, and updating power and position for each of the plurality of players; and identifying a consensus position and ending the simulation if none of the plurality of players receives an offer.

In another aspect, a computer-based system for using predictive analytics to support decision-making on an issue. The system includes a processor; and a storage medium operably coupled to the processor. The storage medium includes program instructions executable on the processor for identifying a plurality of players involved in the issue; determining, for each of the plurality of players, a priority of the issue for each player, a power of each player to influence the issue, and a position of each player with regard to the issue; simulating a plurality of rounds of negotiation between each of the plurality of players, wherein each round includes steps of calculating a median voter position, calculating an expected utility for each of the plurality of players, each of the plurality of players receiving a plurality of offers from at least one other player, each of the plurality of players accepting one of the plurality of offers, and updating power and position for each of the plurality of players; and identifying a consensus position and ending the simulation if none of the plurality of players receives an offer.

Other aspects of the invention will become apparent by consideration of the detailed description and accompanying drawings.

### BRIEF DESCRIPTION OF THE DRAWINGS

FIG. 1 shows the general structure of embodiments of Potentia;

FIG. 2 shows an embodiment of a procedure for extracting the Influential Players from the GDELT database;

FIG. 3 shows possible roles for subject matter experts in predictive analytics;

FIG. 4 shows an embodiment of a procedure for extracting the supporters of a player from the GDELT database;

FIG. 5 shows an embodiment of a procedure for implementing the Potentia prediction core;

FIG. 6 illustrates a representative sequence of plays in a game tree for an expected utility model;

FIG. 7 shows scenarios in an expected utility model in polar coordinate space;

FIG. 8 shows a game tree of all possible strategies for one player in an embodiment of Potentia;

FIG. 9 shows a wheel and spoke display of player positions for one round of Example 1.

FIG. 10 shows a round by round timeline display for Example 1.

FIG. 11 shows a wheel and spoke display of player positions for a basecase of Example 2.

FIG. 12 shows a round by round timeline display for Example 2.

FIG. 13 shows an influence network display for Example 2.

FIG. 14 shows the position of a first group of players over different rounds in Example 3.

FIG. 15 shows the position of a second group of players over different rounds in case Example 3.

FIG. 16 shows the position of a third group of players over different rounds in case Example 3.

FIG. 17 shows the median voter position in each round in Example 3.

FIG. 18 shows the position of a first group of players over different rounds in Example 4.

FIG. 19 shows the position of a second group of players over different rounds in Example 4.

FIG. 20 shows the Median voter position in each round in Example 4.

FIG. 21 shows the position of a first group of players over different rounds in Example 5.

FIG. 22 shows the position of a second group of players over different rounds in Example 5.

FIG. 23 shows the median voter position in each round in Example 5.

FIG. 24 shows Aref and Ruhani's coalition in Example 5.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The study, science, and practice of public policy are undergoing a revolution spurred by significant advances in data science and predictive analytics. While traditional subject matter expertise may still be used as part of the analytic process, the capacity to absorb, filter, and, most importantly, analyze truly massive amounts of information is beyond the capability of the human mind. The various streams of essentially unlimited amounts of data now flow to the decision-maker, who is/are quickly overwhelmed by the volume and velocity of the information. The information overload often leads to information paralysis, where no useful information from the preceding stages of this process practically contributes to decision-making. In many cases, the decision-maker is obliged to default to other ways to arrive at a decision, such as:

TRUSTED SOURCE: Decision-maker chooses to reply on his/her own judgment, or a trusted advisor/s for help in reaching their decision, or

REFLEXIVE: Decision-maker takes whatever decision is most expedient to accomplishing urgent/immediate challenges, even if these decisions create far greater complications longer term.

This dysfunctional process has gone on for some time now, with the information mountain building by the day, while overwhelmed decision-makers are forced to make the best of the situation by falling back on methods that effectively ignore information age advances.

A solution to this problem is the use of predictive analytics. Predictive analytics augments subject matter expertise by leveraging computational data science methods to rapidly provide optimized solutions to diverse problem sets, and data visualization helps make these complex results immediately clear to the human end user.

Embodiments of the invention disclosed herein will bring substantial increases in predictive power, far broader scope of analysis, and dramatically more rapid and cost-efficient policy/decision support capacity. The disclosed methods and systems permit converting data generated by the analog environment into digital data, allowing a far more useful understanding of both the current conditions and more accurate predictions about the future and, perhaps most importantly, defining the steps needed to achieve the future outcomes that are desired.

As a result of advances such as these, public and private sector leaders can make better informed, quicker, and more accurate decisions. For this analytics revolution to succeed, however, it will require a multi-disciplinary platform of domain experts, data scientists, policy practitioners, and visionary leadership.

The field of predictive analytics brings together three fields: statistics, data mining, and machine learning. Statistics uses advanced mathematics to gather and analyze numbers, allowing inferences and deductions on large amounts of data from a small sample size. Data mining also analyzes large amounts of data and by summarizing, classifying, and clustering the data, it finds useful patterns, links, and associations within the data. Finally, machine learning “teaches” a computer model to adjust its responses to adapt to new data and refine itself for increasingly effective results.

Taken together, these three fields form the essence of the presently-disclosed methods and systems, referred to herein as Potentia. Potentia, as a predictive analytics software tool, blends these three fields, along with select supplementary software, to yield optimized decision support on a wide range of business and strategy questions. While such predictive analytics driven forecasting functions may be referred to as “decision support,” in some embodiments the Potentia methods and systems may be referred to as providing “solution support.” This is because of the capability of certain embodiments of Potentia to provide decision makers with proposed solutions to issues, perhaps some they have not even considered, rather than solely providing quantitative data support for decisions they have already reached through more traditional methods. Thus, in various embodiments, Potentia provides a predictive analytics solution support system.

An important driving force of the recent surge in predictive analysis-based tools and their application to business and strategy is the exponential recent growth in the capacity for computers to process enormous amounts of data relatively quickly and to mine the data for useful, actionable information. The mined data can take two basic forms—structured and unstructured. Structured data, such as a spreadsheet or items already within a database, has clear categories (fields) and values for a defined set of information. Unstructured data, on the other hand, can include a wide range of text in many formats, without any defined categories or organization. Potentia takes maximum advantage of advances in processing both kinds of data.

Potentia can process structured data from an existing database or accept manual data input from a data technician. In various embodiments, Potentia may gather, analyze, classify, and create predictions from unstructured data. Potentia utilizes various algorithms to filter, sort, prepare, and analyze huge volumes of data. In addition, Potentia applies an Unstructured Information Management (UIM) program to help process unstructured data, such as that available on the Internet.

Unstructured data is data which is not stored in databases in a given structure or format. Unstructured generally data falls into two categories, non-textual and textual. Non-textual unstructured data may be in form of images such as jpg or png files, audio files, and video files or other types of non-text format. Textual data is in text format, including anything from news websites to emails, social media posts, weblogs, articles, books, newspaper and any other data in the form of text. Potentia mines, manages, and processes structured and unstructured data to populate the input data as the base-case of the issue to be predicted.

Potentia takes advantage of existing relational and non-relational databases in each domain, including GDELT (Global Database of Events, Language and Tone) and GFP (Global Fire Power). Using predetermined algorithms and supervised learning methods, Potentia queries these databases and processes the information to calculate metrics that then are used to determine the influential players, their capabilities, priorities, and positions on the issue.

Processing unstructured data means extracting structure from it. For example, sentiment analysis, also known as opinion mining, determines what kind of judgment, evaluation, or even emotional state is conveyed and can be determined by processing unstructured text and analyzing how the words fit together. The text is then assigned a polarity that identifies the text to be positive, negative, or neutral. Another example is context analysis or topic extraction, which also uses advanced unsupervised machine learning algorithms to extract the main topic or context and environment of a document.

Potentia finds pieces from the unstructured data with the topic and context same as the issue to be predicted, reads and processes the data into individual events, and extracts metrics including identification of the actors along with each actor's tone and sentiment about the issue. Potentia then codes and stores the data in a structured database to be utilized in the same manner as the structured data in pre-existing databases. In various embodiments, Potentia may use known coding schemes such as CAMEO and IDEA to code the events extracted from the unstructured data.

Disclosed herein are embodiments of an intelligent decision support method and system that can assist decision-makers in any domain which includes human negotiations, competitions, and coalitions. In various embodiments, Potentia may include at least two parts. One part may include a data-crawler which uses data-mining methods to process substantial amounts of online data relating to the problem at hand and comes up with the input for the core. Another part may include a prediction core which uses approaches such as game theory and machine learning methods to come up with a possible flow of a particular problem at a future time as well as a possible outcome for the problem. Other features include the ability to shock the system by modifying the situation while the core is running and observing the results and the ability to give suggestions to a specific player in order to achieve the best possible outcome. Adjustments may be made to permit the data-crawler and prediction core to work better in specific domains.

Decision-makers try to obtain as much help as they can get to make better decisions. Decision-support tools vary from consultations with subject matter experts to mathematical and computer-based prediction and analysis models. Computer-based models are divided into two main categories. The first group use “big data” analyses to find similar patterns in historical data to come up with a possible similar future outcome. The second group use Game Theory to consider the current situation as well as all possible future moves in order to analyze the choices that any player can possibly make and predict the outcome based on this information. Knowing the possible outcomes of an ongoing problem beforehand can help decision-makers allocate their resources more mindfully and make better moves and decisions. These tools are not about predicting the exact outcome of the issue, but instead are about giving the decision-maker an edge, another input to use alongside their own knowledge and experience. This edge, even if small, can significantly favor the decision-maker individuals, institutions, and parties in the long run. Any person who steps into a casino has a 48 percent probability of winning which gives the house 52 percent probability of winning. The casinos make all the profit from this 4 percent probability difference which, when multiplied by the number of the customers who come to a casino every night, leads to millions of dollars of profit for the casino.

Potentia merges human tools, such as consultation with experts and consideration of different scenarios, together with computer-based tools, such as those based on big data and game theory, into an elaborate yet user-friendly framework.

There are limitations to the existing game-theory based prediction models. The most important limitations are the ones caused by input data that is produced by interviewing subject matter experts. The game-theory based prediction models are very sensitive to the input and thus a small change in the input can make a big difference in the predicted outcome. Problems that might arise when producing input by interviewing experts include, but are not limited to, the possible bias in the expert's opinion, lack of information about a specific aspect of the issue, and possibility of making a mistake during the interviews with the experts. These limitations, however, can be alleviated by interviewing many experts and averaging out the results. A more serious limitation in this kind of data collection is the quantification of the information gathered from experts, which occurs when one converts the multi-dimensional qualitative information obtained from the experts' opinions down to a single number to be fed into the prediction model.

Potentia addresses all of these limitations. The universe of information pertaining to the problem is processed and the data is interpreted to provide the input needed for Potentia, addressing the problem of lack of information. Furthermore, multiple layers of quality control and data noise elimination reduce the likelihood of mistakes being made in gathering expert input. The scenario is considered from multiple points of view, including that of the media, ordinary people, experts, published articles, and books, which helps eliminate the possible bias in the information taken from one or more experts' opinion. To address the problem of quantifying the data, Potentia uses scientific and complex methods developed by the experts in this area.

Critics of game-theory-based prediction models point to the fact that human beings are different from machines and do not always follow equations. These critics believe that humans' decisions are not completely rational and can often be influenced by emotions or sudden changes. Nevertheless, Potentia accounts for emotions by considering players' characteristics like risk-taking ability, security level, and flexibility. More importantly, Potentia provides the possibility for the expert or other user to “shock the system” by inputting sudden changes in the process or factoring in possible emotional decisions which might affect the outcome of the prediction at any stage.

Another important feature of Potentia is its use of a Monte Carlo Decision Tree search algorithm to search in the huge game tree of all the possible moves and paths for a given player, allowing it to come up with the best path to take to reach the best possible outcome. This is the most important point of knowing what will possibly happen, namely the ability to look back and correct the mistakes that led to a loss and take the moves that can lead to better outcomes which otherwise would have been missed.

While many of the examples disclosed herein are focused on international conflicts, other possible domains in which Potentia can be used include:

Negotiation Support (public and private)

Business—marketing, risk analysis, supply chain management

Commodity Price Movement—oil, precious metals

Healthcare—patient flows, disease trends

Dynamic Resource Allocation (energy, housing, manpower)

Climate Modeling & Simulation

Sports

National Security

Counterterrorism, Crime Control

Local, National, International Application

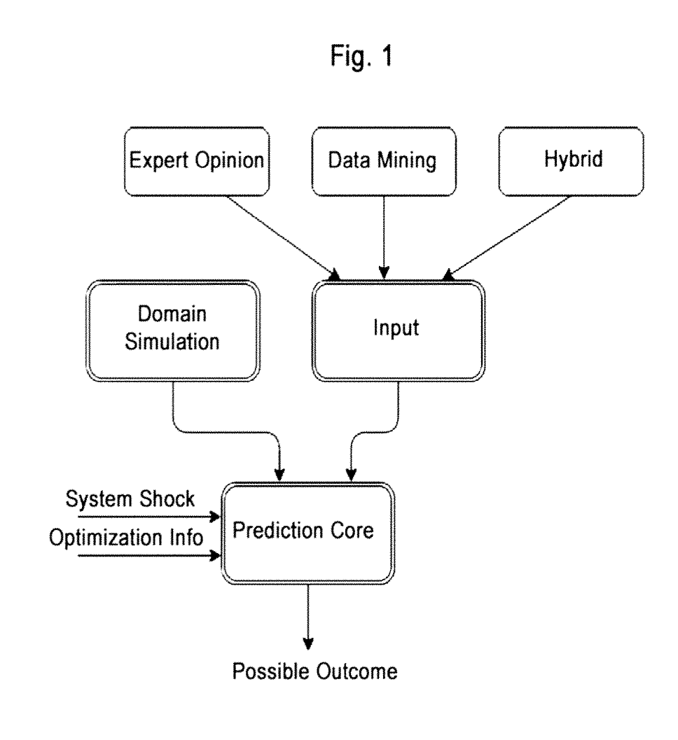

FIG. 1 shows a diagram of certain embodiments of the Potentia system. As with other prediction models, the input is an important and sensitive part of the Potentia system and thus slight inaccuracies in the input can lead to large differences in the predicted outcome. The input, which is carefully monitored, may be provided by subject matter experts and/or may be collected from outside sources, e.g. the Internet/world wide web. A hybrid of inputs from these and other sources may be employed, and in some embodiments an expert may conduct quality-control and other adjustments to the collected data.

As an initial step before running the Potentia prediction core in a given simulation, certain factors may be adjusted to account for differences in problems in different domains. In certain embodiments, these adjustments may include modifying the cooperation rate and compromise level depending on how competitive or cooperative the environment is. Other adjustments that may be made prior to running the Potentia prediction core include accounting for how and when an influential player is allowed to influence the issue and whether the problem has different steps. An example of a multi-step problem having different players involved at each step is the process that a legislative bill goes through in internal policies of the United States.

Repositioning the actors of an issue is based on the outcome of the challenge offers actors send and receive in each negotiation round. Based on the perceived and real expected utility of a particular actor, there are generally three likely outcomes for a challenge offer made by a player: a player might win a challenge, lose a challenge, or make a settlement to compromise which can be in their favor or otherwise. When a player is considering to make a challenge offer to another player, it tries to calculate its own possible utility gained from this challenge and the respective utility lost by the other actor. It also makes an estimate of the other player's capabilities and power to make sure the challenge offer can be successfully enforced. These perceptions and estimates are not always true and may lead to losing or a negative compromise.

How the actors react when they win, lose, or compromise in an offer depends on the nature of the issue. In completely non-cooperative issues, there are just two possible outcomes for each challenge offer, namely wining or losing, and there is no compromise. The player who loses has to completely change its position to the position of the winner. Non-cooperative issues include those in which the question to be answered, or the problem to be predicted, is a discrete question with a yes-no answer for which anything in the middle has no meaning. In more cooperative issues, depending on the difference between the expected utility of the winner and the other player, a complete shift or a compromise might happen. If the expected utility of the winner is not big enough to be able to force the other player to completely move to its own position, a positive compromise happens in the favor of the winner. If the expected utility of the winner is large enough, the other player completely moves to the position of the winner. A completely cooperative issue is when the players of the issue agree on a mutual position in every round and there in no absolute winning or losing to each offer. Both players move to the mutual position after the outcome of the offer is determined, although the player who loses the challenge has to move (i.e. change their position) more. The “cooperativeness factor,” which can be set for each issue before running the algorithm, affects whether or not players make compromises and, if they do, the degree to which they will compromise. In other words, if the players agree to meet somewhere in the middle of their ideal positions, the cooperativeness factor will determine where the mutual position is located.

After the input is provided and the environment is adjusted, the Potentia prediction core starts processing the information to come up with the possible outcome of the issue. Besides showing the possible flow of the issue and the situation to reach the possible outcome, various embodiments of Potentia provide additional features as follows:

(1) System shock: the user has the ability to look at what will possibly happen at each round of negotiation and shock the system with arbitrary changes and analyze what will happen if these changes are enforced. For example, when the user notices a coalition is being formed between two or more players (which is indicated by those two or more players adopting the same position), the user can “shock” the system, e.g. by giving more power to one of the members of the coalition, to see if the coalition will hold or break. This feature also gives the user the ability to explore the effect of emotional decisions or irrational position shifts of any given player at any point of time until the issue settles.

(2) Optimization: Potentia may provide a “best strategy” recommendation to any given player. Information about the player name, the ideal outcome, and the range in which the player can maneuver can be input to the Potentia core and Potentia will determine the best strategy for the player to reach an outcome closest to its ideal outcome.

Input Creation

In various embodiments, the input to the Potentia system includes a list of the influential players and at least three attributes for each player. In certain embodiments, the input is generated based on the current situation of the players at the time the study is opened. One attribute for each player is its Ideal Outcome, i.e. the end result that that player would ideally like to achieve, which may be depicted on a one-dimensional left-to-right continuum. Another attribute is Priority, which represents the importance of the issue for the player. Still another attribute is Power, which shows the ability of the player to influence the issue, combined with the resources available to it.

In some embodiments the input may be entered into the Potentia user interface manually. In other embodiments, Potentia can automatically identify the players and the attributes for each player by obtaining and processing data which relates to the issue (e.g. data available on the Internet and/or from other sources). Examples of input data may be generated in an automatic or a semi-automatic manner, particularly in the context of international binary conflicts, are disclosed herein.

In particular embodiments Potentia may obtain data from the Global Database of Events, Language and Tone (GDELT), which is supported by Google Ideas. The GDELT Project monitors broadcast, print, and web news from numerous countries in over 100 languages and identifies the people, locations, organizations, themes, sources, emotions, counts, quotes, and events driving global society on an ongoing basis. GDELT includes data starting in 1979 and has more than 300 million events that have been captured, coded, and classified with 58 attributes for each event. GDELT is updated and hundreds of thousands of events are added to it every single day. Information is stored in GDELT in the form of events. An event can be as simple as a single phone call, a meeting, or a statement a political party makes about an issue, or as important as a major explosion or a military attack. Thus, a database such as GDELT is particularly suitable for obtaining information for issues in domains such as international conflicts.

Each event in GDELT has a maximum of two actors, information about the actors such as their names and which country they are from, as well as their institutional affiliation, religion, and ethnic group, if any. The database also includes geographical information about where the event took place and where the news was published. Further information includes attributes about the date the event happened, when it was captured, and when it was added to GDELT, as well as attributes about the event itself. Events are classified in four categories: material cooperation, material conflict, verbal cooperation, and verbal conflict, and each event includes a code that provides additional details about the event. For example, the code 03 means “express intent to cooperate”, the code 030 means “express intent to cooperate, not specified below”, the code 031 means “express intent to engage in material cooperation, not specified below”, the code 0311 means “express intent to cooperate economically”, and the code 0312 means “express intent to cooperate militarily”. There are also attributes about the importance of the event such as number of mentions of the event and the Goldstein Scale, which represents the positive or negative impact of the event on the stability of a country. In addition, GDELT may include source attribute that stores a URL or other link to the source of information about the event.

The data in GDELT is automatically coded by the CAMEO (Conflict and Mediation Event Observations) coding system. CAMEO is a framework for coding event data typically used for events that merit news coverage and is generally applied to the study of political news and violence. CAMEO is built on top of the TABARI (Text Analysis By Augmented Replacement Instructions) program, which is an event coding program produced by the Penn State Event Data Project. As the open source C++ successor to the KEDS program, CAMEO has added a number of capabilities not present in KEDS that facilitate parsing and grammatical recognition.

While some examples included herein utilize information obtained from the GDELT database, this is not a requirement for Potentia and in various embodiments input information pertaining to players and attributes of the players may be obtained from a number of other databases or sources, including de novo data collection and analysis and/or expert curation. The sources of information that should be considered for different domains are different. A database for a given domain may be developed using coding mechanisms such as CAMEO (discussed above), Computation with Words, Deep Learning, Neural Networks, and Computational Linguistics. These methods will be used to better interpret the data, reduce false data, and capture the hidden meanings and sentiments of the text. In various embodiments, additional information may be employed to gauge and quantify how ordinary people see the problem (e.g. by mining social media); how mainstream media perceives and presents the problem (e.g. from analyzing television/radio, print media, and online news sources); and how experts view the problem by processing scholarly articles, books and publications, the experts' weblogs, public statements, and interviews. In various embodiments, a specific interface will be developed for each data source that is utilized and in general the output of these specialized interfaces will be comparable to that produced from the GDELT database for input to Potentia. However, based on the specific problem domain and the parameters available for the data source, mining and processing of the data may vary using the methods mentioned above.

In various embodiments, an initial step for Potentia to create input is to obtain a definition of the problem to be studied from the user. In various embodiments, the user is queried (e.g. through a user interface) to name at least two players (e.g. countries) that are involved in the conflict as well as to identify the issue the conflict is over. The issue may be entered as a series of keywords, as few or as many as the user finds relevant to the issue. The user interface then asks for the date the conflict was initiated so that the system can review events from the identified start date up to the present. In certain embodiments the default start date is set to the year 2001, although the start date may be changed to any date through the aforementioned user input (e.g. the conflict between India and Pakistan over the Kashmir region began well before 2001).

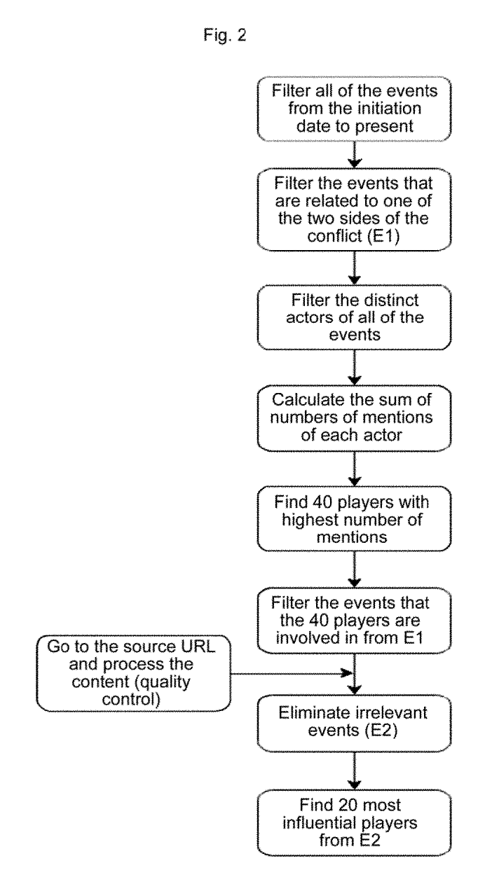

In certain embodiments, an additional step for creating input is to identify Influential Players, such as individuals, parties, or countries (depending on the domain of the conflict) that are stakeholders in the issue. FIG. 2 shows an embodiment of a process Potentia may use to find the top Influential Players (e.g. the top 3, 5, 10, 15, 20, or other number of players) involved in an issue. In some embodiments, identifying Influential Players includes steps of: filtering all of the events from the initiation date to the present (e.g. to select only the events relating to the keywords provided by the user); filtering the events to identify only those events that are related to one of the two (or more) sides of the conflict (step E1); filtering the distinct actors of all of the events (i.e. identifying actors involved in the subset of events that were identified in the previous step which relate to the sides of the conflict); calculating the sum of numbers of mentions of each actor; finding a number of players (e.g. 40 or other number) having the highest number of mentions; filtering the events that the players with the highest number of mentions are involved in from E1 (i.e. selecting only the events which involve one of the players with the highest number of mentions); eliminating irrelevant events (step E2); and identifying the most influential players, e.g. the top 3, 5, 10, 15, 20 etc. players with the highest number of mentions that are remaining after eliminating irrelevant events.

In FIG. 2, the term “filter” generally means steps of running appropriate queries and fetching data from the database. In some embodiments, subsequent queries may be run to narrow down the results to more relevant information. For example, to obtain information pertaining to all of the events that are related to an issue to predict, the events are first filtered by event code and then by main actors and geographical location of the events and actors. In certain embodiments, the errors in event coding (e.g. in the GDELT or other database) as well as limitations in specifically fetching data that is related to a given issue, there sometimes are “irrelevant events” in the results which are not related to the issue that is being predicted. To address this problem, a keyword based quality control layer may be used on top of the data fetching process which connects to the source of the event, reads the text of the page, and searches for specific keywords to confirm that the fetched event is about the issue at hand; if not, that portion of the data is rejected as irrelevant.

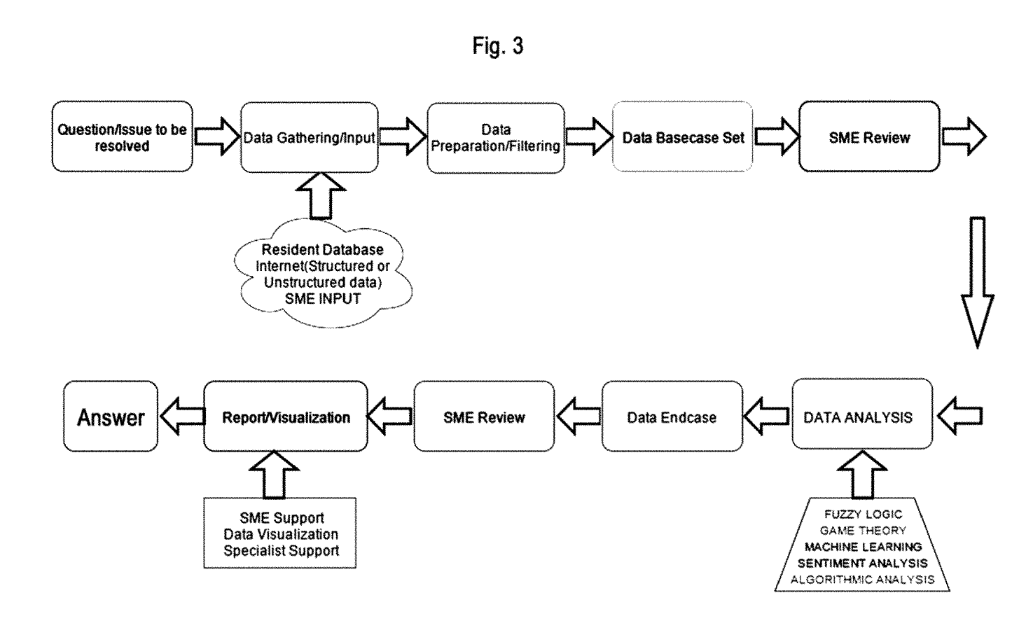

In certain embodiments, prior to the step of eliminating irrelevant events (step E2), a “quality control” step may be performed on the data, for example a subject matter expert (SME) or other party may access the source material (e.g. at an Internet URL or other resource) and process the content at that source to confirm its accuracy. As shown in FIG. 3, the Potentia predictive analytics process begins with data gathering/input, then filtering, and finally algorithmic analysis. At several steps along the way, SME (Subject Matter Expert) review is built into this process. The SME may be helpful for ensuring the integrity of the data collected, the basecase that is established, and the endcase that is reached. Finally, the SME, along with data visualization experts, processes the final data (the endcase) into text, graphs, maps, and charts for the report.

Having identified the Influential Players (for example using the process disclosed above), Potentia may then determine parameters for each of the Influential Players for a given issue, including a priority of the issue for each player, a power of each player to influence the issue, and a position of each player with regard to the issue.

In certain embodiments, an automated method for determining the Priority of an issue to a player may be based on a number of times a player refers to the issue in a public setting or takes an action that is related to the issue, either of which may be taken as an indication of the importance of the issue to the player. For example, when searching in the relevant events for an issue in the GDELT database, the number of times that a player is identified as “Actor 1” (i.e. the term used by GDELT for the primary actor for an event) for an event provides an indication of the Priority of the issue for the player. In general, the Priority for the countries who are the two sides of the conflict is always equal to 1. In certain embodiments, Potentia finds Priority for each of the other players as follows:

$${Priority}_{i} = \frac{{n}_{i}}{Max ( {n}_{i} )}$$

where nᵢ is the number of times player(i) has been the initiator of an event related to the issue and the term “Max(nᵢ)” is the maximum number of times that any of the active players has been the initiator of an event related to the issue. Thus, this formula normalizes the priority values relative to the player that has been the initiator of an event the largest number of times.

There are a number of factors that may be considered in order to estimate the Power attribute for each Influential Player, and these factors may differ depending on the domain. In the domain of international conflicts, for example, the Power of a country may be a combination of one or more of monetary power, military power, manpower, population, resources, and other similar factors, along with the amount of support from allies and the power of those supporters. In some embodiments, the Power index may be determined by extracting and identifying the supporters of a country from GDELT and using the Global Fire Power(GFP) index for each of the supporters as a shorthand way to represent numerous factors such as those listed above. The GFP ranking is based on a formula utilizing over fifty factors to measure a nation's power. These factors may include (but are not limited to) oil production and consumption, military power, labor force, geographical location, and external debt, along with land, air, and naval weapons. The 2015 GFP index ranges from the most powerful country being United States with an index of 0.1661 and the least powerful being Somalia with an index of 5.7661. In various embodiments, to use GFP in Potentia it may be converted to an index that ranges between 0 and 1, with the most powerful player holding the index of 1. Thus, the GFP index is converted to the Potentia GFP(PGFP) as follows:

$${PGFP}_{i} = \frac{Max ( {GFP}_{i} )}{{GFP}_{i}}$$

When it comes to applying the Potentia algorithm to competition problems in fields outside of international relations such as business, the “Power” of each player (e.g. company/business) depends on many factors. Some of these factors are the key statistics of the company itself such as Market Capitalization (Market Cap), Enterprise Value, revenue, growth, profit and, in some cases, Trailing P/E, Forward P/E, PEG ratio.

In some embodiments additional factors can be taken into account, for example, factors to measure the extent to which a firm acts independently of its competitors and customers. These factors may include the overall size of the firm, control of the infrastructure that is not easily duplicated, technological advantages, absence of buying power, privileged access to capital markets/financial resources, product diversification, economies of scale, economies of scope, vertical integration, a highly developed distribution network, absence of potential competition, and barriers to expansion.

Characteristics of the market should also be considered as a factor in calculating the market power of each player in the game. There are some quantitative measures of market dominance that can be used, such as the Herfindahl-Hirschman Index (HHI)², which is an index of the number of firms in the market and their market shares, and the Lerner Index, which measures the degree to which prices exceed marginal cost.

As mentioned above, there are many factors that may be considered and not all of them are present or apply to all problems, businesses, and markets. Therefore, there is no unique equation in literature that captures every factor and can assign a single “power” index to compare businesses in a specific market. Thus, in situations such as this a hybrid of Subject Matter Experts (SMEs) and Artificial Intelligence may be utilized. For many well-known markets, SMEs assign a relative overall power index to the main companies or businesses. A machine learning algorithm is then trained with those indexes and all factors about the markets and businesses, and computational power of super computers is relied upon to find the best equation that maps the factors on those indexes in each market. The algorithm might determine that some factors do not have any effect in this market based on the indexes the SME has provided, or on the contrary, it might find some factors to be much more important than the others. We can then use this equation to calculate the power index of any given business/company in the same market or a different market with the same features.

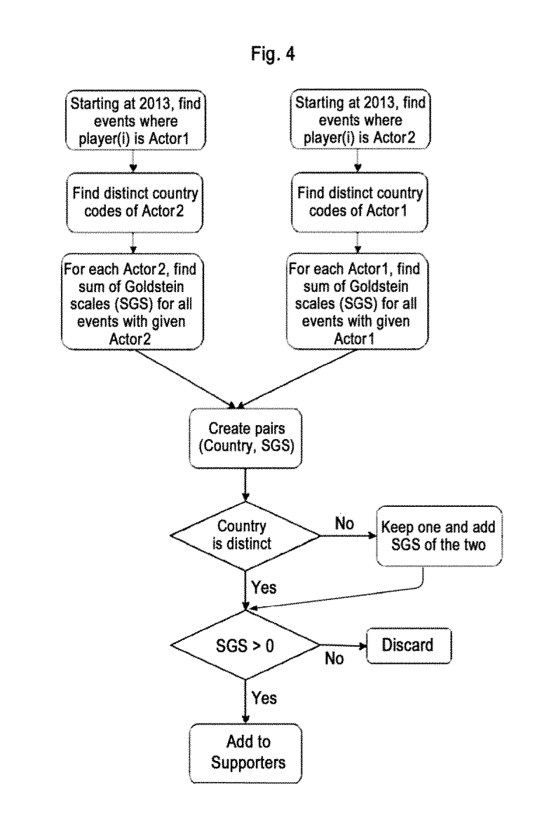

Next, the amount of support for the player is estimated. For finding a player's allies, all events related and unrelated to the issue since 2013 (or other suitable date, depending on factors such as when the conflict began and the availability of data from earlier or later dates) are processed and all interactions between the player and any other country are reviewed and the countries that overall have had positive attitude and cooperation with the given player are identified, as the foreign policies and relations of a country are important factors determining a country's overall Power in the world. FIG. 4 shows the process Potentia uses to find the supporters for each Player. The amount of support for each player is then calculated as follows:

$${Support}_{i} = \frac{{\sum }_{j = 1}^{N} {PGFP}_{j}}{Max ( {\sum }_{j = 1}^{N} {PGFP}_{j} )}$$

The Power attribute for Player, is a linear function of PGFPᵢ and Supportᵢ. α and β in the following equation are currently both assumed to be equal to 1. In various embodiments, these values may be optimized by conducting further research and consulting with subject matter experts in international affairs.

$${Power}_{i} = \frac{α \times {Support}_{i} + β \times {PGFP}_{i}}{α + β}$$

The Ideal Outcome for each player is the end result that each player would like to achieve. To populate the Ideal Outcome attribute for each player in the domain, Potentia puts the two sides of the conflict on two extreme ends of an Ideal Outcome continuum. The events related to the issue are processed and other Influential Players are positioned on this continuum based on their overall attitude towards the two extreme sides of the conflict. To find the Ideal Outcome for Playerᵢ on a scale of 0 to 100, two assumptions are made:

1—The first side of the conflict is holding an Ideal Outcome of −100

2—The second side of the conflict is holding an Ideal Outcome of 100

Then for all events where one of the players is Playerᵢ and the other player is the first side of the conflict, the sum of the Goldstein scale values(SGS1ᵢ) is calculated; a similar procedure is followed for the second side of the conflict(SGS2ᵢ). The Ideal Outcome for Player, (IOᵢ) is then calculated as follows:

$${IO}_{i} = 100 \times \frac{SGS {2}_{i} - SGS {1}_{i}}{{Max}_{j = 1}^{N} ( SGS {2}_{j} ) - {Min}_{j = 1}^{N} ( SGS {2}_{j} )} + 100$$

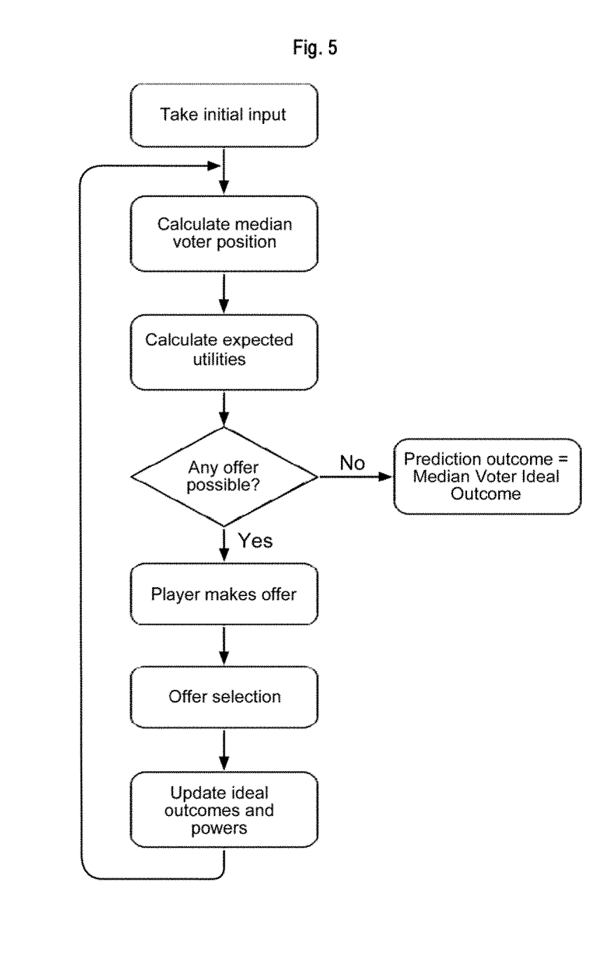

FIG. 5 shows a flow of processes in the prediction core for certain embodiments of the Potentia system. Operation of the prediction core is based on repeated rounds of negotiation and challenge offers going from one player to the other at the end of each round. In general, the players try to first predict the winner of each round at the beginning of the round, and then try to position themselves somewhere that is closer to the predicted winning position and at the same time not too far from their own initial Ideal Outcome. Each player also tries to predict which other player(s) they can convince (or force) to join them.

The following is a description of the overall design and structure of embodiments of Potentia, which takes three arrays as the input. A median voter position is then calculated using the initial input, where the median voter position is the position of the player which, when compared with every other player, is preferred by more votes; the median voter position definition and calculations will be described further below. At each iteration, the player whose ideal position is closest to the median position is most likely to be the winner for that iteration. Then the players start to negotiate. They calculate the payoff (expected utilities) for themselves to challenge every other player and decide to whom they will make challenge offers. After the offers are made, each player reviews the offers it has received and selects the one that maximizes its own payoff. This results in a change in the position and power for some of the players and a possible shift in the position of the Median Voter. Another round of negotiation starts with the new positions and repeats until the game reaches an equilibrium, that is, when all players are satisfied with their position, given the position of other players in the game, and no offer can possibly result to a positive payoff for any player, i.e. a consensus position has been reached. The game ends at this point and the Median Voter position in this round is Potentia's prediction to be the winning position. FIG. 5 shows a general flowchart of the algorithm, which in certain embodiments may be based on expected utility theory.

One of the strengths of Potentia is that its input may be limited to three arrays of data, arrays which define each player's initial state. A first array is the array of positions (x[ ]), that is, where each player stands on the issue. Each player has an ideal position, which can be depicted on a one-dimensional left to right continuum, such that the more two given players' ideal outcomes conflict, the greater their distance apart on this scale. The unit of this position is specified for each given problem. A second array, the array of priority or salience (s[ ]), determines the priority of the issue and how much importance it holds for each player. A third array, the array of power or capability (c[ ]), determines how much power or capability a player has with respect to the issue. Table 1 represents an example of these three arrays taken from an example in which the issue was stated as: “What is the attitude of each stakeholder with regard to the floor price of oil in three months' time at which Saudi production should decrease?”

In some embodiments, the Potentia model includes an application of Black's median voter theorem and Banks' theorem on the monotonicity between certain expectations and the escalation of political disputes. The median voter theorem states that a majority rule voting system will select the outcome most preferred by the median voter. In each round of negotiations, the player whose position is closest to the median voter position is the winner, indicating that the winner is the player who has more support from others. The votes for j versus k, are:

$${v}^{jk} = {\sum }_{i = 1}^{n} {v}_{i}^{jk} \qquad ( 1 )$$

The difference between the distance of player is position from that of player j and player k is calculated and normalized. This, multiplied by player i′s power and priority, shows player i′s support for player j versus player k which is vᵢ^{jk} in the equation. This support is calculated for each player. The sum of the support player j gets versus player k and every other player is the total support it can get in the associated round. The total support is calculated for all players and the position of the player that has the maximum total support is the median voter position in that round.

TABLE 1
Sample of the input.

| Players | Capability | Position | Salience |
|---|---|---|---|
| HAWKS | 0.65 | 14.25 | 0.80 |
| IRAN | 0.85 | 14.20 | 0.85 |
| RUSSIA | 0.55 | 14.20 | 0.65 |
| IPEC | 0.70 | 14.10 | 0.75 |
| GULF | 0.50 | 14.10 | 0.75 |
| MILITARY | 0.75 | 14.10 | 0.75 |
| KUWAIT | 0.65 | 14.00 | 0.90 |
| TRIBALS | 0.85 | 13.95 | 0.85 |
| RELIGIOUS LEADERS | 0.95 | 13.90 | 0.90 |
| BUSINESS | 0.60 | 13.75 | 0.80 |
| SULTAN | 0.95 | 13.40 | 0.95 |
| MAJLIS | 0.45 | 13.35 | 0.75 |
| ABDULLAH | 1.00 | 13.25 | 0.90 |
| FAHD | 1.05 | 13.00 | 0.90 |
| USA | 0.60 | 13.00 | 0.70 |
| NAZER | 0.80 | 12.90 | 0.85 |
| EUR/JPN | 0.75 | 12.85 | 0.75 |

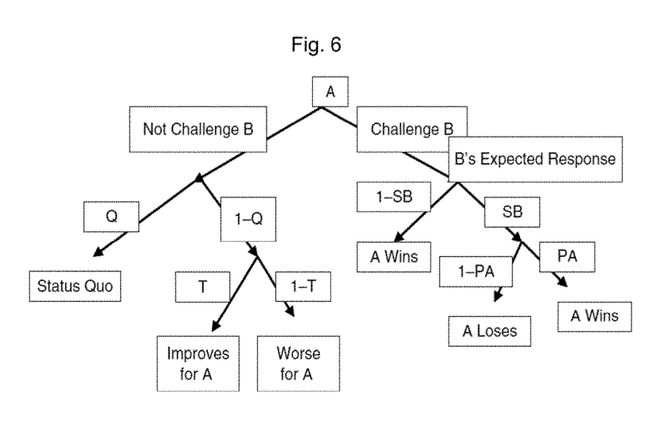

In each round, players make challenge offers to other players aiming to make others shift their positions towards their ideal position. In various embodiments, a simulation may include at least 10 rounds, at least 20 rounds, at least 50 rounds, or at least 100 rounds. These offers are made based on the expected utilities calculated for each player versus each of the other players. Players try to maximize their own payoff by making offers to players whom they think they can convince or force to make a coalition with. At the same time, players try to respond to the offer that leads to the maximum payoff for them or at least requires them to move the least from their ideal position. FIG. 6 illustrates a representative sequence of plays.

The expected utility of player(i) for challenging player(j) from player(i)'s point of view can be calculated as:

Eⁱ(Uᵢⱼ)=Sⱼ(PᵢⁱUₛᵢⁱ÷(1−Pᵢⁱ)U_{fi}ⁱ)+(1−Q)Uₛᵢⁱ−QU_{sq}ⁱ−(1−Q)(TU_{bi}ⁱ÷(1−T)U_{wi}ⁱ) (2)

According to FIG. 6, Sⱼ is the priority or salience of the issue for player j, Pᵢⁱ is the probability of success for player i, Uₛᵢⁱ is the expected utility of success for player i, U_{fi}ⁱ is the expected utility of losing for player i, Q is the probability of status quo, U_{sq}ⁱ is the expected utility from remaining in stalemate, T is the probability that situation improves for player i when it does not challenge player j, and U_{bi}ⁱ is the expected utility in this situation. U_{wi}ⁱ is the expected utility in the situation that player i does not challenge player j, player j is challenged by others and the results of these challenges worsens the situation for player i. μ is the median voter position at each iteration.

Equation (2) is estimated from four perspectives:

(1) is expected utility for challenging j from i′s point of view

(2) j′s expected utility for challenging i from j′s point of view

(3) is expected utility for challenging j from j′s point of view

(4) j′s expected utility for challenging i from i′s point of view

The calculation of U_{bi}ⁱ, U_{wi}ⁱ, Uₛᵢⁱ, U_{fi}ⁱ, and U_{qi}ⁱ are explained in further detail in Scholz et al. (2011; Journal of Theoretical Politics, 23, 510-531; incorporated by reference herein) according to the following equations:

$${U}_{si}^{i} = 2 - {4 [ 0.5 - 0.5 \vert \frac{{x}_{i} - {x}_{j}}{{x}_{max} - {x}_{min}} \vert ]}^{{r}_{ij}}$$

$${U}_{fi}^{i} = 2 - {4 [ 0.5 + 0.5 \vert \frac{{x}_{i} - {x}_{j}}{{x}_{max} - {x}_{min}} \vert ]}^{{r}_{ij}}$$

$${U}_{bi}^{i} = 2 - {4 [ 0.5 - 0.25 \vert \frac{( \vert {x}_{i} - μ \vert \vert {x}_{i} - {x}_{j} \vert )}{{x}_{max} - {x}_{min}} \vert ]}^{{r}_{ij}}$$

$${U}_{wi}^{i} = 2 - {4 [ 0.5 + 0.25 \vert \frac{( \vert {x}_{i} - μ \vert \vert {x}_{i} - {x}_{j} \vert )}{{x}_{max} - {x}_{min}} \vert ]}^{{r}_{ij}}$$

$${U}_{sq}^{i} = 2 - 4 {( 0.5 )}^{{r}_{ij}}$$

The above equations are used to calculate the expected utility of player i for challenging player j from i′s point of view. xᵢ is the position of player i, xⱼ is the position of player j, xₘₐₓ is the highest position in the game and is the lowest position in the game. rᵢⱼ is the risk component for player i versus player j.

When player i wants to make an offer to player j, it calculates its own expected utility from this challenge and compares it to what it perceives of player j′s expected utility versus himself, leading to the conclusion that:

$${U}_{si}^{j} = 2 - {4 [ 0.5 - 0.5 \vert \frac{{x}_{i} - {x}_{j}}{{x}_{max} - {x}_{min}} \vert ]}^{{r}_{ji}}$$

$${U}_{fi}^{j} = 2 - {4 [ 0.5 + 0.5 \vert \frac{{x}_{i} - {x}_{j}}{{x}_{max} - {x}_{min}} \vert ]}^{{r}_{ji}}$$

$${U}_{bi}^{j} = 2 - {4 [ 0.5 - 0.25 \vert \frac{( \vert {x}_{i} - μ \vert \vert {x}_{i} - {x}_{j} \vert )}{{x}_{max} - {x}_{min}} \vert ]}^{{r}_{ji}}$$

$${U}_{wi}^{j} = 2 - {4 [ 0.5 + 0.25 \vert \frac{( \vert {x}_{i} - μ \vert \vert {x}_{i} - {x}_{j} \vert )}{{x}_{max} - {x}_{min}} \vert ]}^{{r}_{ji}}$$

$${U}_{sq}^{j} = 2 - 4 {( 0.5 )}^{{r}_{ji}}$$

Using U_{bi}ⁱ, U_{wi}ⁱ, Uₛᵢⁱ, U_{fi}ⁱ, and U_{qi}ⁱ, Player j′s expected utility versus player i, from player i′s point of view, is E^{j}(Uᵢⱼ):

E^{j}(Uᵢⱼ)=Sⱼ(PᵢⁱUₛᵢⁱ+(1−Pᵢⁱ)U_{fi}ⁱ)+(1−Sⱼ)Uₛᵢⁱ−QU_{sq}ⁱ−(1−Q)(TU_{bi}ⁱ+(1−T)U_{wi}ⁱ) (3)

The probability of success for player i in competition with player j is also calculated by the support of third-party players for player i′s policies versus player j′s policies. Similar to finding the median voter position, it is not only about which player's policies the parties prefer, but also the third-parties' priority or salience on the issue and their capability or power are considered. Equation (4) shows the probability of success for player i in competition with player j according to the Expected Utility Model (Scholz et al., 2011; Journal of Theoretical Politics, 23, 510-531).

$${P}_{i}^{i} = \frac{{\sum }_{kifarg > 0} {c}_{k} {s}_{k} ( \vert {x}_{k} - {x}_{j} \vert - \vert {x}_{k} - {x}_{i} \vert )}{{\sum }_{k = 1}^{n} {c}_{k} {s}_{k} ( \vert {x}_{k} - {x}_{j} \vert - \vert {x}_{k} - {x}_{i} \vert )} \qquad ( 4 )$$

where xᵢ, xⱼ, and xₖ are the positions for player i, player j, and player k respectively. cₖ is the power of player k and sₖ is the priority or salience and importance of the issue for player k.

The numerator calculates the expected level of support for i. The denominator calculates the sum of the support for i and for j so that the expression shows the probability of success for i, and it obviously falls in the range of 0 and 1.

In various embodiments, the probability of status quo (Q) can be calculated for each pair of players. According to FIG. 6, when A does not challenge B, B is challenged by other players and may lose and be forced to move. If B moves, its position changes and its distance to A either decreases (with probability T) or increases (with probability 1−T). Therefore, the probability of status quo in this situation is the probability that B does not move at all. This is the probability that B wins the challenge with every other player except A in that round. This probability is calculated as follows:

Qⱼⁱ=Π_{k,k≠i,k≠j}(Pₖⁱ+(1−Sₖ))

The probability that player(i) wins every challenge against another player(k), is the sum of two probabilities. First, the probability that player(i) challenges player(k) and player k does not challenge it back and surrenders which is (1−Sₖ). Second, the probability that player(i) challenges player(k) and player(k) does respond to its challenge and again player(i) wins this confrontation which is Pⁱ. The probability that player(i) wins against every other player except player(j), is the multiplication of this sum for all players except player(j).

According to FIG. 6, when A decides not to challenge B, but B moves due to other challenges, its move either improves or worsens the situation for A. B move would be towards the median voter position, so the positions of A, B and the median voter (μ) versus one another determines whether B moves closer to A or further away from it. If B moves closer to A, it improves the situation for A, so T=1. If B moves further away from A, it worsens the situation for A, so T=0.

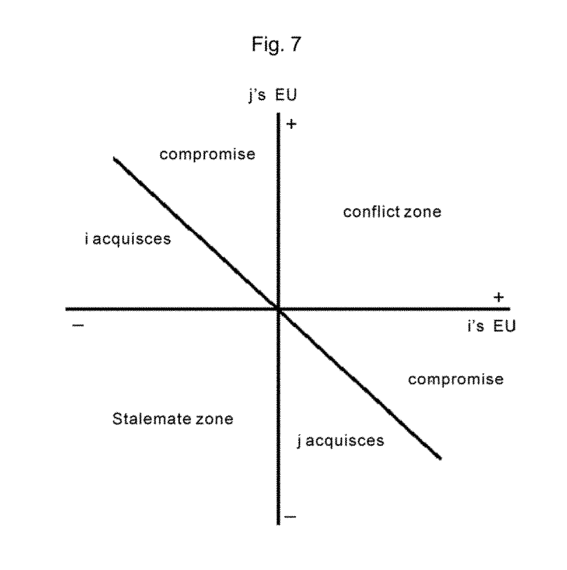

The probability with which confrontation, compromise, or capitulation occur can be displayed in a polar coordinate space. This space is divided into six sections and the boundary between each two is considered to be a turning point in the probability functions. FIG. 7 shows this polar coordinate space, along with associated labels for each of the six sections.

In various embodiments of Potentia, if two players both assume they have the bigger utility compared to the opponent and that their utility is big enough to make the other player move to their position, they both make challenge offers to one another and they both stick to their offer and they confront, which has a high cost for both players. If a player thinks it has bigger utility, but not big enough to make the other player completely move to its own position, he offers a compromise. If the other player responds to this offer, they both move towards each other, in some cases by a weighted average of i′s and j′s expectations. If a player receives an offer and knows that the proposer is too strong for it to challenge, it gives in and completely moves to the proposer's position. If both players think there is no positive utility in challenging each another, they make no offer and stay in the stalemate zone.

The median voter position is calculated at the beginning of the first round of negotiation and is selected to be the winner position of the game with the initial positions, powers, and priorities. At the end of each round of negotiation, each player has a set of offers that it has to choose from and then each responds to the one that it considers to be the best choice to maximize its payoff. If such an offer does not exist, the player chooses the offer that requires it to move the least from its ideal position. After all players have selected the offer they want to respond to, they move to the position associated with the offer and the arrays of positions and powers are updated. In the following round, the median voter position, the probabilities of success and status quo, the expected utilities, and the risk factors are all calculated with the updated position array, and then new offers are made. The game continues until it reaches an equilibrium, which is when no player has an offer to make to the other players, given every other players' position. In this situation, all players prefer to stay at their current position. The median voter at this final round would be the winning position. The player whose ideal position in the initial array of inputs is nearest to this median voter is most likely to be able to enforce its ideal outcome.

In various embodiments Potentia may include a risk taking component. This function calculates a risk or security value for each player in confrontation with all other players, and Potentia may include a learning module as part of this function to model the thinking of each player. The players learn from the offers they make in each round. When player(i) makes an offer to player(j) and does not result in a positive pay off, he concludes that he had underestimated player(j)'s abilities which means that next time he will be more careful in confronting player(j). On the other hand, when player(i) can enforce an offer he has more confidence in confrontation with player(j) in the future.

The risk-taking component of the Expected Utility Model is a trade off between political satisfaction and policy satisfaction. Political satisfaction or security is being seen as a member of winning coalition while policy satisfaction is supporting the policy that is closest to that of the player itself even if that policy does not win. The rate at which each player makes this trade-off is different from that of the other players. The security of a player increases and the risk decreases by taking a position close to the median voter position. Therefore, the players who take positions close to the median voter position (i.e. the player who is the winner at the associated round) are those who feel more vulnerable and tend to be more risk averse. What enters the calculation of risk in the Expected Utility Model, is the actual expected utility, the maximum feasible expected utility and the minimum feasible expected utility. Algebraically, the risk-taking component is calculated as follows:

$$\begin{matrix}{R}_{i} = \frac{2 {\sum }_{i = 1}^{n} {E}^{i} {U}_{ij} - {\sum }_{i = 1}^{n} {E}^{i} {U}_{{ij}_{max}} - {\sum }_{i = 1}^{n} {E}^{i} {U}_{{ij}_{min}}}{{\sum }_{i = 1}^{n} {E}^{i} {U}_{{ij}_{max}} - {\sum }_{i = 1}^{n} {E}^{i} {U}_{{ij}_{min}}} \\ and & ( 5 ) \\ {r}_{i} = \frac{1 - \frac{{R}_{i}}{3}}{1 + \frac{{R}_{i}}{3}} & ( 6 )\end{matrix}$$

As seen in Equation (3), the risk factor is used in the calculation of expected utilities, and according to Equation (5), risk is calculated using the expected utilities. In various embodiments, the expected utilities are first calculated without considering the risk (r=1) and then these utilities are used to calculate the risk for each player.

The purpose of Equation (6) can be that r[i] ranges between 0.5 and 2. However, according to this equation, the greater R[i], the smaller r[i]. So r[i] is actually the level of security rather than risk of player i. That explains why expected utilities are exponentially increasing by r which is a positive number between 0.5 and 2. This security level is calculated in each round, taking into account the support each player gets from other players, the expected utilities, and the distance from the median voter position.

While the present algorithms produce a model premised on expected utility theory, there are certain deficiencies of this theory that the presently-disclosed algorithms improve upon. What seems to be left out in the Expected Utility Model is that players cannot look ahead in rounds or even look back and learn from their mistakes or achievements. There are several rounds of negotiations before players reach an equilibrium and the game comes to an end. It is possible that player(i) underestimates player(j)'s capabilities and its supporters and makes a challenge offer and consecutively loses some utility. In reality, this should change player i′s assumptions about player j, and therefore, next time when i wants to make an offer to j, does it more conservatively. To monitor the offers and to learn from the outcomes, we have modeled the thinking of each player. Others have calculated r[i] for each player using the security for player(i) in confrontation with any other player. In contrast, Potentia extends the security to be a two-dimensional array: R[i] [j] is the risk of player i in confrontation with player j. The array is initialized with the risk calculated from the Expected Utility Model in each round and then adjusted in each round.

The learning matrix is formed as follows:
Make a two-dimensional matrix named learn and initiate it to all 0,
At the end of each round, each player monitors the offers it has made,
If a proposal has been made by i and not responded to by j, decrement learn [i] [j] by 1,
If a proposal has been made by i that leads to confrontation in which i has to move towards j, decrement learn [i] [j] by 3,
If a proposal has been made by i that leads to compromise in which i has to move more than j, decrement learn [i] [j] by 2,
If a proposal has been made by i that leads to i having to capitulate and move towards j, decrement learn [i] [j] by 3,
If a proposal has been made by i that leads to confrontation in which j has to move towards i, increment learn [i] [j] by 1,
If a proposal has been made by i that leads to compromise in which j has to move more than i, increment learn [i] [j] by 2,
If a proposal has been made by i that leads to j having to capitulate and move to i, increment learn [i] [j] by 3.

As specified above, the learn matrix is updated after each round by considering each offer and its outcome for the proposer. If the outcome is positive, it increases the security player i feels to challenge player j next time. However, if the outcome is negative, player i learns that it had underestimated player j′s expected utility versus its own and its security level versus player j decreases. The greater the number of the losses or gains, the more effective is the learn matrix.

The risk is adjusted as follows: r[i] [j] elements are initiated with r[i] of the Expected Utility Model. Then in each iteration:

rᵢⱼ=rᵢⱼ+β×Sᵢ×learn[i] [j] (7)

The security level is updated after each round and kept in the memory of each player for future rounds. Equation (7) indicates that the more importance or salience an issue has for a player, the less risk that player can afford on the issue. If a player is rather indifferent on the issue, the experience of a loss or an unseen opportunity will not be so heavy on that player. The possibility of this player making the same mistake again is more than a player to whom the issue is of great priority and importance. That is why the learning rate is not considered to be constant for each player as it is in Q-learning. The learning rate is a multiplication of salience and a constant β.

In certain of the Examples below, the value β has been set to 0.01, although in various embodiments this value may be higher or lower. The value of 0.01 was selected experimentally given the fact that this value should be very small, but not too small so that it can make a difference. It should be small because the risk factor is in the range of 0.5 and 2 and if β is too large, it will change the risk factor irrationally and might even push it out of range. Furthermore, if β is too small, it does not make any difference in the outcome of the equations when added to the initial risk factor. Experimenting with different values of β for the different problems in hand, it became clear that different problems have different tolerance for the level of increase in β before starting to respond irrationally.

An advantageous feature of Potentia is that it can be configured to utilize powerful computers (e.g. supercomputers) to process all possible moves and approaches for a given player. The possible outcomes for these strategies may then be processed to suggest the moves that will lead to the most favorable outcome for the given player. In general, there are a very large number of possible strategies for each player. Thus, if there are n influential players and therefore a maximum of n ideal outcomes, there are n possible moves for a given player in each round. If it takes m rounds of negotiation for the issue to be settled, the number of possible strategies for a player could be as large as n^{m}, and the number of strategies for a 20-player issue that goes on for 80 rounds before being settled will be 20⁸⁰. For each possible strategy Potentia would need to run the scenario and analyze the reactions of other players, generate the possible outcome, and compare it with the outcome of other scenarios as well as with the ideal outcome that the influential player wanted to reach. The computational complexity for all of these steps is so great that the amount of time it would take to exhaustively consider every possibility would be prohibitive, even with the most powerful computers currently available.

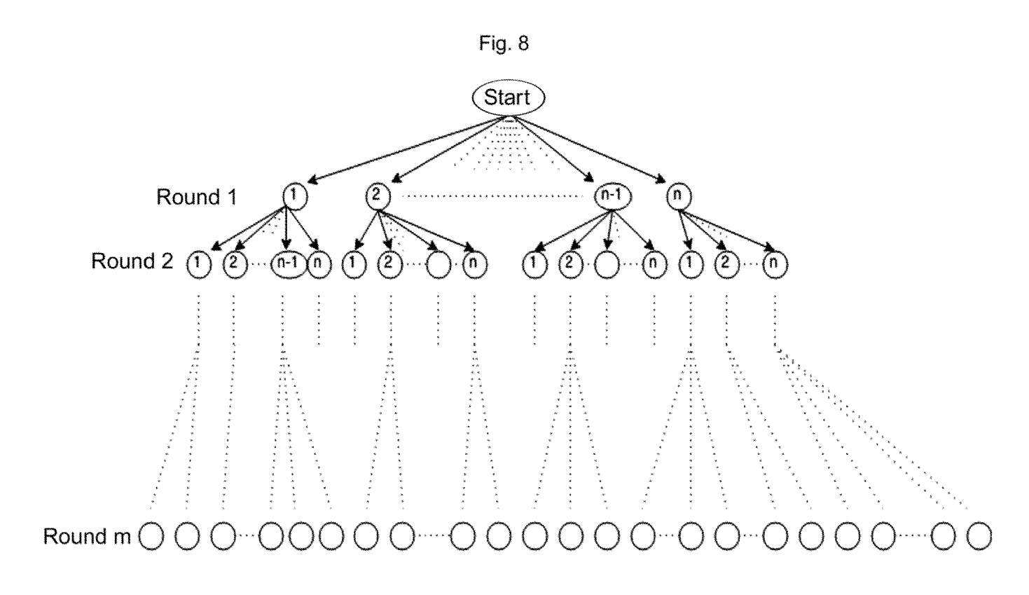

To demonstrate the complexity of the problem, FIG. 8 shows a game tree for the possible strategies for any given player in an issue with n influential players which is supposed to resolve in m rounds of negotiation. However, instead of calculating all possible outcomes for every possible scenario, a Monte Carlo Tree Search(MCTS) method is employed instead. The back-propagation value which is assigned to all nodes of the path after running the scenario is a function of the distance between the outcome reached by taking this strategy and the ideal outcome of the player. Each time the algorithm attempts to identify the node that will possibly lead to the outcome with the least distance from the ideal outcome. The ties between nodes (shown as arrows in FIG. 8) are broken randomly, which satisfies the balance between exploration and exploitation in the tree. In one embodiment, the algorithm searches at least 100 million possible strategies, because even if a strategy that leads to the ideal outcome is reached before that, it is possible that another strategy may be found which leads to the same outcome but has less cost or is more realistic or easier to take.

System Shock

The course of human interactions of the type that are simulated using Potentia, for example interactions between nations, groups, or businesses, can take irrational turns or experience “black swans”. To help users prepare to counteract (or, in some cases, advantageously initiate) such counterintuitive inputs, Potentia features a “system shock” capability. To create such a “system shock”, in various embodiments Potentia is capable of modifying the case, for example by adding and removing players, and/or changing the Ideal Outcome, Priority, or Power of one or more players at any point of time. This gives Potentia the ability to process the effect of otherwise-unpredictable decisions (e.g. emotional decisions) as well as sudden changes in opinion and to account for the possibility of players making mistakes. This feature also can help the user analyze what will happen if, at a certain point at time, a player leaves the picture or a fake player with a given Ideal Outcome and amount of Power comes into the picture. In addition, if the user notices a coalition is being formed, he/she can shock the system by giving more power to one of the members of the coalition to see if the coalition will break or not. While watching the flow of the issue (e.g. on a representation of the simulation on the user interface), the user can pause the system at any given point and change any attribute of the players and delete or add one or more players. The Potentia core remembers the information about the issue, the players, and the environment that had been gained up to the point of the system shock, then updates the information gained from the system shock, and continues the prediction/simulation.

Accuracy

Potentia is a powerful forecasting and solution support predictive analytics tool which has achieved forecasting results between 80-90% accuracy compared to two models made by a pioneer in the field, Dr. Bruno De Mesquita (referred to as BDM New Model and BDM Old Model in Table 2). Table 2 shows the results of tests using a constant large data set based on 162 issues from the European Union (162 EU Issues; see Journal of European Public Policy 19:4 May 2012: 604-622; data available at: www.robertthomson.info/research/resolving-controversy-in-the-eu). To facilitate comparison of data, all of the issues in the accuracy report are predicted with a fixed default cooperativeness factor and this factor is not set on an issue-by-issue basis. As shown by the dramatically lower error deviation value in Table 2, Potentia is substantially more accurate in correctly predicting future outcomes.

In various embodiments, the invention may include a computer-based system for carrying out the methods disclosed herein. The system may include one or more computer systems in communication with one another through various wired and wireless communication means, which may include communications through the Internet. Each computer system may include an input device, an output device, a computer-readable medium, and a processor. Possible input devices include a keyboard, a computer mouse, a touch screen, and the like. Output devices include a cathode-ray tube (CRT) computer monitor, a liquid-crystal display (LCD) or LED computer monitor, and the like. Computer-readable media include various types of memory such as a hard disk, RAM, flash memory, and other transient and non-transient magnetic, optical, physical, or electronic memory devices. The processor may be any typical computer processor for performing calculations and directing other functions for performing input, output, calculation, and display of data in the disclosed methods and systems. Implementation of the system may include generating a set of instructions and data that are stored on one or more of the storage media and operated on by a controller, where the controller may include a processor as disclosed herein. The data associated with the system can include image data and numerical data. In certain embodiments, the invention may include a computer-readable medium having instructions for carrying out embodiments of the present invention.

In one embodiment, the system may include a web page for facilitating input, control, analysis, and other functions. In other embodiments, the system may be implemented as a locally-controlled program on a local computer system which may or may not be accessible to other computer systems. In still other embodiments, the system may include modules which provide access to portable devices such as laptops, tablet computers, and smart phones.

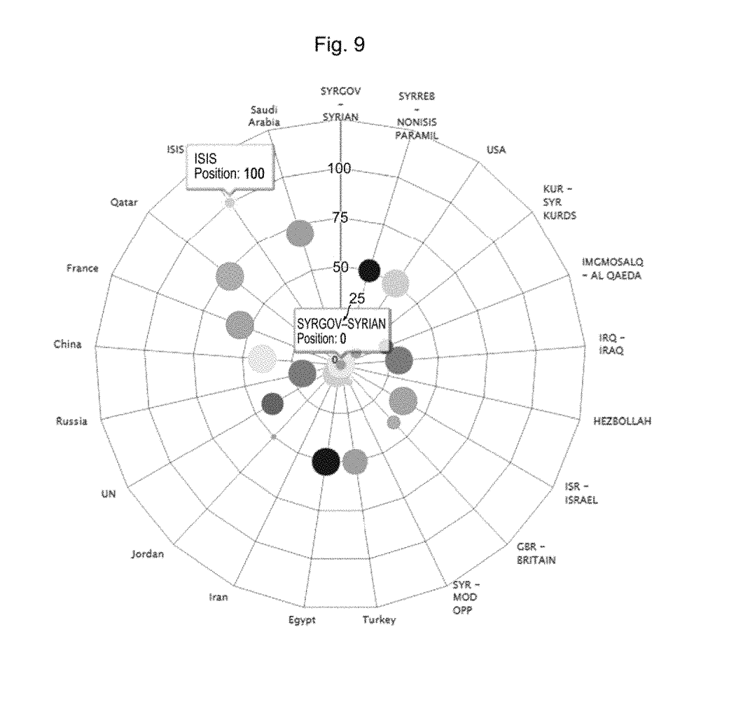

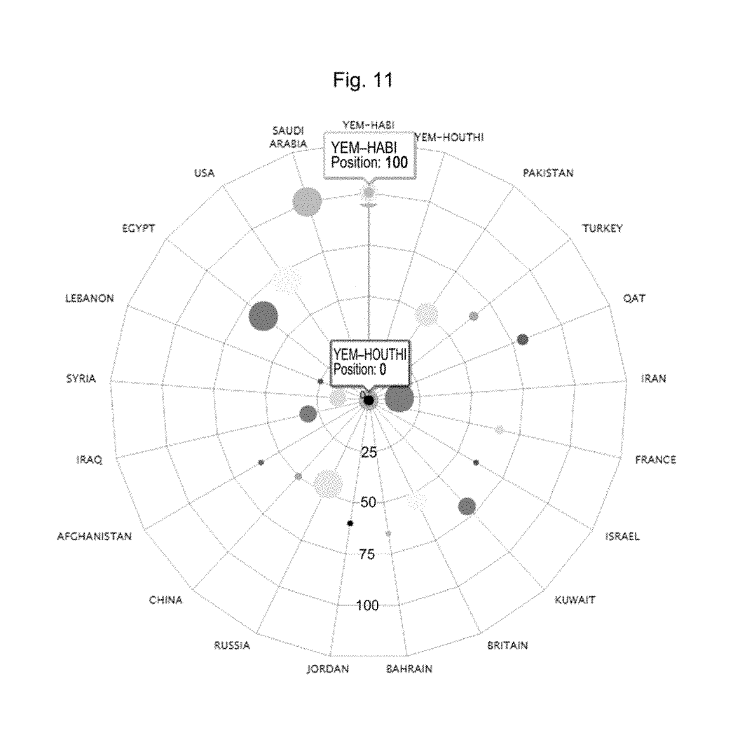

In some embodiments the output of the simulation may be presented in one or more ways to facilitate user interpretation, including wheel and spoke display, a round by round timeline, or an influence network display. In a wheel and spoke display, the players are shown as spokes with the two extreme positions occupying either the hub or the periphery (i.e. the distal ends of the spokes away from the hub) and each players' power being visualized by the size of the dot representing each player (FIGS. 9, 11). For each round, each player's position and power is shown by a dot of a given size located along a spoke.

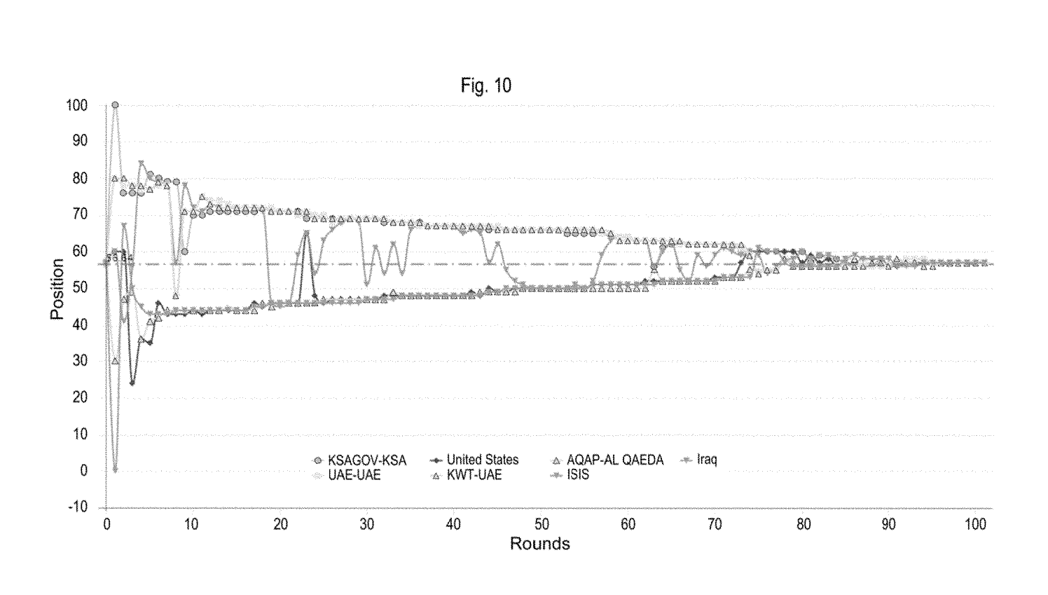

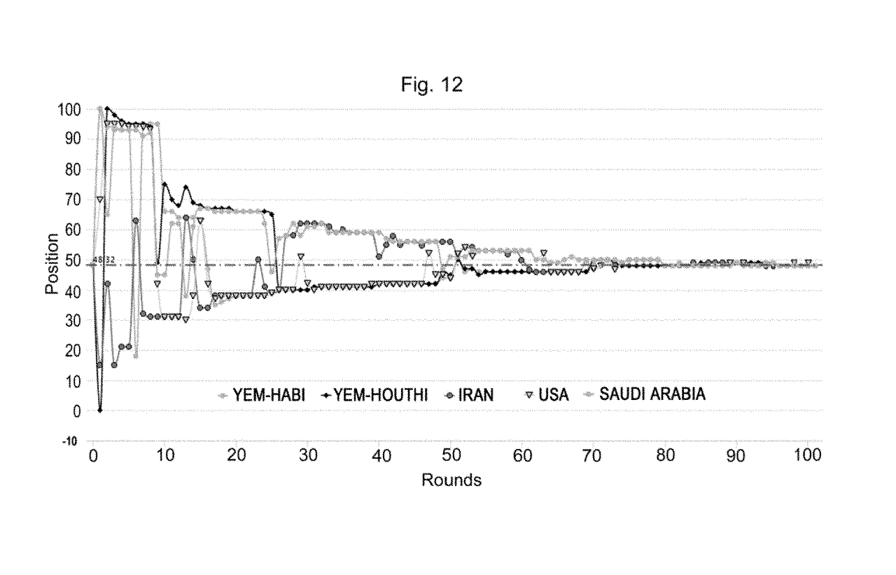

In a round by round timeline, each player's position is shown on the y-axis and the rounds are shown on the x-axis. Assuming a consensus is reached, the traces representing each country will tend to converge towards the consensus position with each passing round (FIGS. 10, 12).

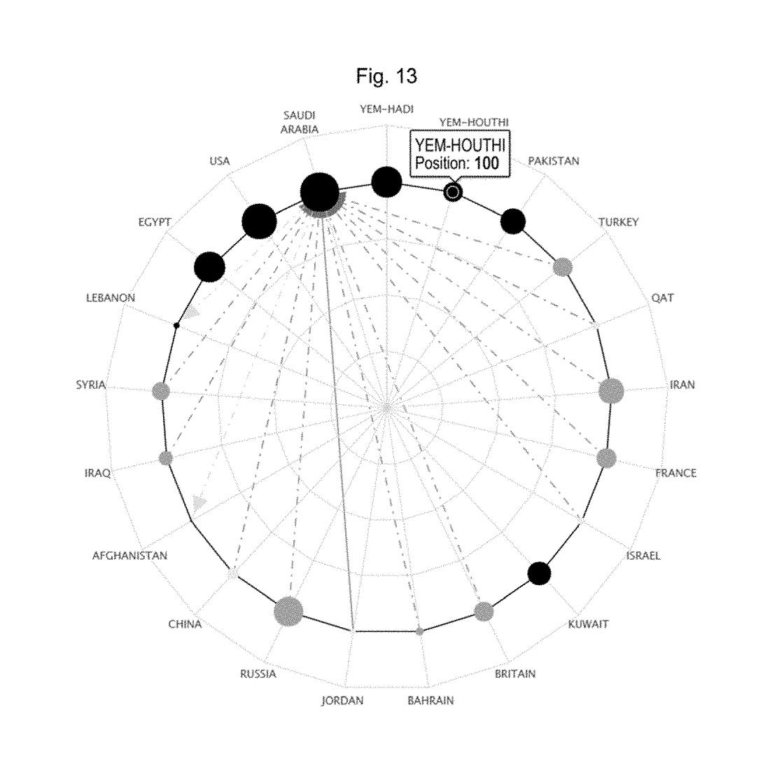

An influence network display shows attempts by players to influence other players and whether the attempts are successful. In the display of FIG. 13, arrows of various colors and line style, and direction are used to show attempted influences to and from a single player, Saudi Arabia. Although the colors may vary, in FIG. 13 green arrows show influences that the player tried to make and blue arrows are influences other players tried to make on the player. When an arrow has a dotted line, the player was not able to actually enforce the influence. When an arrow has a solid line, the influence was enforced. In this example and in this specific round, there are two coalitions that are trying to influence Saudi Arabia as a group, one of the groups is marked by the color blue and the other is marked purple.

In various embodiments, Potentia may be used as an educational tool for training, e.g. government or business leaders, by simulating a scenario and by changing the input vectors to see if a particular outcome is reached. Features of Potentia disclosed herein, such as shocking the system, would provide users in educational settings with a powerful tool to see what happens when parameters of various situations change.

The following non-limiting Examples are intended to be purely illustrative, and show specific experiments that were carried out in accordance with embodiments of the invention:

### EXAMPLES

### Examples 1 and 2

### Saudi Security

Saudi Arabia is moving rapidly to adapt to changing conditions in a volatile region. Preparing Saudi Arabia to effectively counter threats and seize opportunities requires harnessing the best available technology. Military hardware, advanced and secure communications, and state of the art energy and resource technology are traditional elements of Saudi security.

Potentia may be used as a means to maximize large sums of money expended on these traditional national security measures and therefore act as an essential and cost-effective force multiplier for Saudi security.

Among the most pressing national security challenges facing Saudi Arabia at the time of this paper are the conflicts in Yemen and Syria. To show Potentia's capability, two predictive analysis case studies were run to predict the outcome of these conflicts and to recommend the best course(s) of action for Saudi Arabia.

### Example 1

### ISIS in Syria—Predicting Future Outcome

Background: This complex regional conflict involves multiple sub-state actors, subnational organizations, transnational terrorist groups, regional powers, and great powers. The government of Bashar al Assad, the president of Syria, has been under severe pressure from a broad range of forces since Arab Spring inspired popular protests engulfed Syria in 2011. At first, popular outrage drove the resistance to Assad, but soon Al Qaeda and various similar extremist organizations joined the movement. Some purportedly moderate opposition groups funded by Western powers failed to achieve any traction either militarily or among the populace, and soon were largely marginalized by the extremists. Syrian Kurds in eastern Syria used the upheaval to press for their own rights and sought their own advantage through paramilitary activity, triggering the Turks to get involved. Through 2012 and 2013, the Friends of Syria meetings convened under American leadership pressed Assad to abdicate but he stubbornly held on. In 2013, after alleged Assad chemical weapon use against rebels and civilians, it appeared that international pressure would finally spur large scale Western direct action to remove Assad. Russia intervened, however, to arrange a chemical weapons disarmament agreement that defused the situation and kept Assad in power. Assad has remained in power due largely to two factors: first, Western reluctance to engage in another large Middle Eastern war after the Iraq experience, and second, strong pro-Assad support from Russia, Iran and its affiliate Hezbollah, and Iraq. Then in 2014, ISIS emerged in Syria as an offshoot of various extremist trends and began operations in Syria and soon afterwards Iraq. The ISIS forces called for a transnational caliphate, and rapidly captured large swathes of territory and strategic cities and resource centers in Syria and Iraq, threatening regional stability and global security.

Case Discussion: This Example predicts the eventual outcome of the Syria conflict taking into consideration the involvement of ISIS. The question addressed is: Will Assad remain in power or will a combination of extremist opposition led by ISIS, international pressure, and popular disaffection finally force him from office? In short, will ISIS prevail in Syria? The players involved were identified and for each one power, position, and priority values were determined based upon the hybrid approach disclosed herein. At the extremes ISIS occupied the 100 value (prevail) and Assad the 0 value (defeat ISIS and remain in power) (FIGS. 9, 10). As the predictive analysis was run, two strong coalitions were seen to develop. The first coalition featured the Syrian government, Iran, Hezbollah, Iraq, the Syrian moderate opposition, and Russia. The second featured the US, UN, France, Al Qaeda, Syrian Kurds, Turkey, and non-ISIS resistance. Several other parties were moved between and within these coalitions. The first coalition soon settled around 10-15 (strong support for Assad remaining in power), while the second settled around 60 (moderate support for ISIS displacing Assad). As the analysis continued, these coalitions remained, but started to drift closer to each other, moving towards the final predictive outcome. The final outcome—that is the “winning position”—was 30.34, corresponding to a moderate consensus that ISIS will fail to displace Assad. With this same data, we can run scenarios to determine whether removing a key player from the calculus (or incentivizing them to change their position or other value) could change this outcome in either direction. Thus, based on this analysis it appears that ISIS will fail to remove Assad from power.

### Example 2

### The Yemen Conflict: Predicting Future Outcome

Background: Yemen's Houthis, a Shiite sect based in Yemen's mountainous northwest along the Saudi border, have pressured the Yemeni leadership for greater autonomy for decades. Given their proximity to Saudi Arabia, the Saudi leadership has concentrated attention on border security and maintaining intelligence insight into Houthi activities. The Houthis, though a different subsect of Shiism from the Shiites of Iran, are believed to have received material and financial support from the Iranians, particularly over the past few years. The Houthis' most recent insurrection began in 2004 and remained at a relatively low level until the regional Arab Spring movements eventually displaced Yemen's long-serving president and Saudi ally, Ali Abdullah Saleh in 2012. The resulting unsettled conditions allowed destabilizing forces such as Al Qaeda in the Arabian Peninsula (AQAP) and to a lesser extent Iran, to increase activities in Yemen. Saleh had maintained good relations with the US, as well as Saudi Arabia, and kept order through a complex balancing of tribal and ethnic groups in Yemen's complex polity and financial and intelligence support from outside partners. The American involvement in Yemen sought mostly to counter the dangerous AQAP group, which was active throughout the central Middle East and severely threatened Saudi Arabia and its allies. Iran's support for the Houthis during this time was reportedly limited to some financial and diplomatic support, and was not a major concern of the US or its allies during this time.

In 2014, reportedly with material support from Iran, the Houthis aggressively moved south, capturing cities along their path until they seized the capital Sanaa. After the fall of Sanaa, the internationally recognized successor to Saleh, Abd Rabbuh Mansur Hadi was forced from office, retreating south to Yemen's strategic southern port city of Aden. The Houthis continued their southward advance and took most of Aden in late 2014, forcing Hadi to flee the country. In March 2015, an Arab coalition led by Saudi Arabia initiated Operation Decisive Storm to check and reverse Houthi gains, and ultimately to restore the legitimate Yemeni government. The US and other powers offered logistical and intelligence support, while traditional Saudi allies Egypt and Pakistan have only offered limited backing for the operation, refusing to commit combat forces. Russia has led discussion towards various UN brokered cease fires. Extensive coalition bombing campaigns focused on Sanaa, Aden, and the northern Houthi stronghold have checked Houthi progress. As of late in 2015, Arab coalition troops had entered Aden to restore order and potentially establish a beachhead for a restored Hadi government.

Case Discussion: The case study in this Example considered whether Operation Decisive Storm would succeed in its goals of checking and reversing the Houthi takeover of most of Yemen and ultimately returning president Hadi to power. The aim was to predict the eventual outcome of the Yemen conflict: Would Hadi and the Arab coalition backing him prevail, or would the Houthis and their supporters prevail? Any such analysis should take into consideration that non-military means such as diplomatic negotiations may also play a role, and thus the analysis is not exclusively related to military power. The players involved were identified and to each was ascribed power, position, and priority values based upon the hybrid approach disclosed herein (FIG. 11). At the extremes Hadi and Saudi Arabia occupied the 100 value (Hadi/coalition prevail) and the Houthis the 0 value (Houthis prevail). A strong coalition including most—but interestingly not all—of the Decisive Storm coalition forms early on between 60 and 70, indicating strong support for the Hadi/Saudi position. However, during the course of the simulation this coalition does not hold, and overall coalition participation in this conflict—even among those in the Decisive Storm coalition grouping—fluctuated repeatedly in this case study (FIG. 13). The result was a steady regression towards the mean, with a final outcome of 48.32 (FIG. 12), representing a consensus position. This result suggests that under current conditions, the conflict will be a stalemate, with neither side achieving a decisive outcome, which is not a desirable outcome for the Saudis.

To address this finding, the “Shock the System” feature was activated and the priority figures were adjusted slightly for a few of the actors. In particular, Pakistan's priority figure was increased slightly and Iran's priority figure was reduced slightly, the US priority figure was increased slightly, and the Decisive Storm coalition members' (except Saudi Arabia, which was already at maximum) priority figures were increased very slightly. In the real world, various means may be available to increase or decrease priority or salience of the involved actors, including incentives to increase or decrease their involvement, such as diplomatic engagement, media campaigns, intelligence sharing, and other measures. After making these changes the result was that the new outcome figure stands at 70.36, representing a decisive victory for the Decision Storm Coalition and President Hadi. In a situation like that in this case study—where there was a need to adjust the playing field through directed actions to prevail—subject matter experts could recommend such measures and work as needed with relevant players (e.g. in this case the Saudis) to develop and implement these steps. This case serves as an excellent example of what makes Potentia so valuable—making the difference between a costly, prolonged stalemate and a decisive victory. This Example shows that, with some incentivized adjustments, a decisive Hadi/Coalition victory could be achieved whereas without these adjustments, a prolonged and indecisive stalemate is possible or even likely.

### Example 3

### Predicting the Floor Price of Oil in Three Months Time

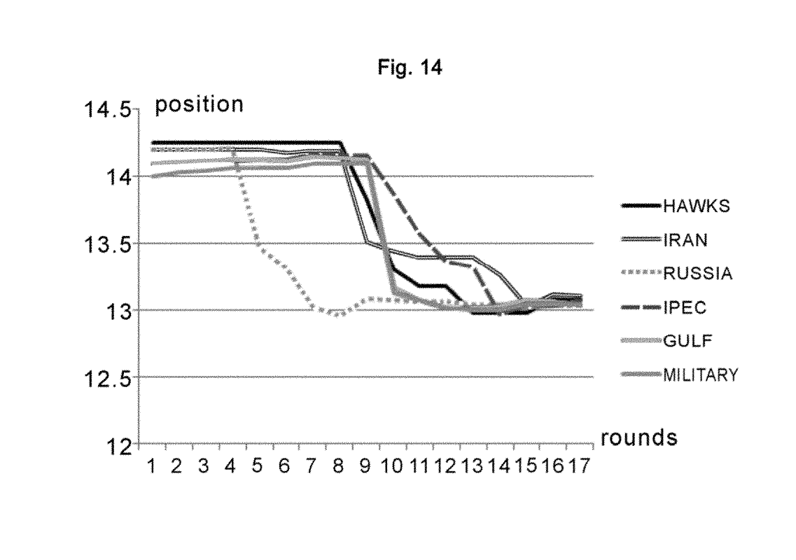

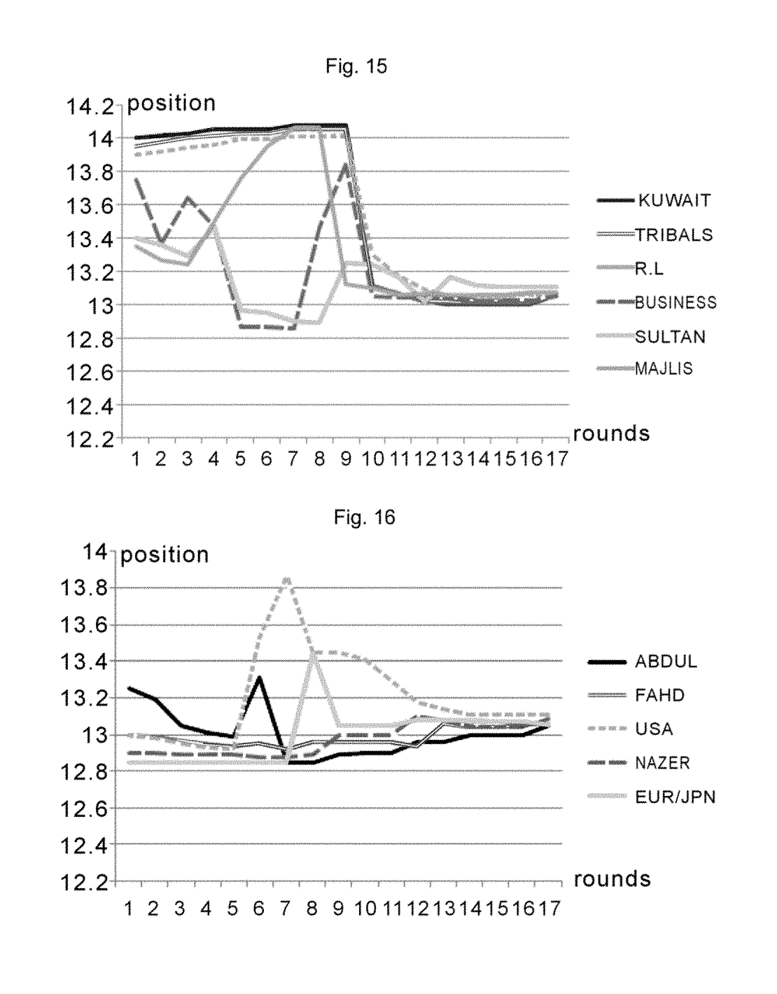

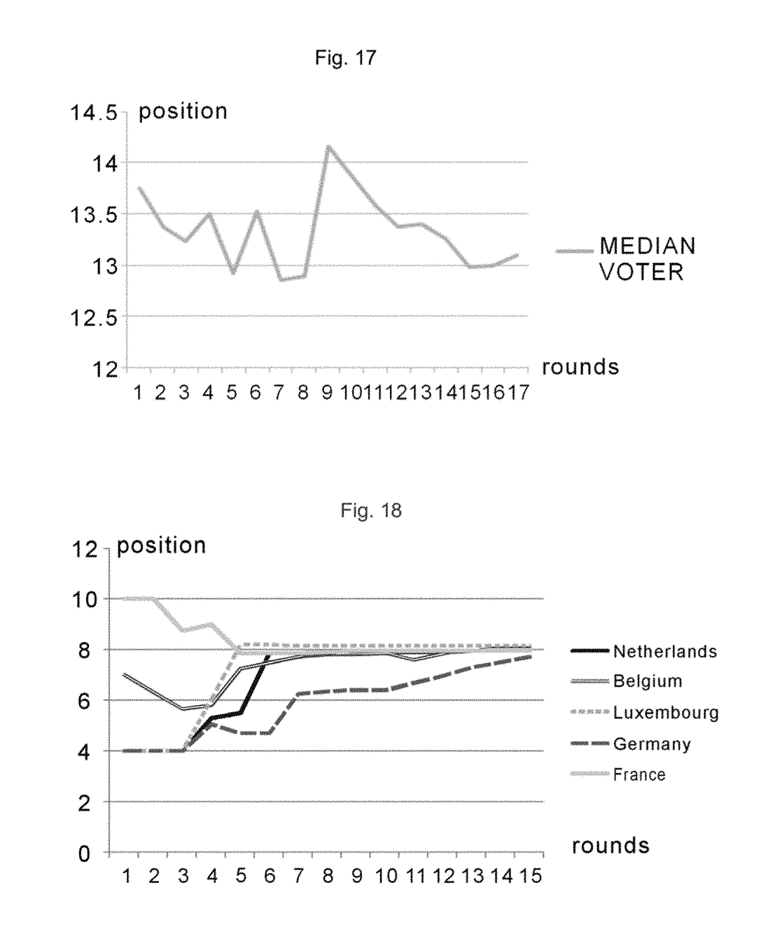

This Example uses as input the data shown in Table 1, which is from de Mesquita (1997; Empirical and Theoretical Research in International Relations, 23, 235-266; incorporated by reference herein). FIGS. 14-17 show the players' positions and the winning position in subsequent rounds. As seen in FIGS. 14-16, all of the players in this game change their positions over rounds until they all reach a position very close to the winning position, which is 13.11. FIG. 17 shows the Median voter or the winning position in different rounds of negotiations, which ends up to be equal to 13.11 in the last round where equilibrium is reached.

The price predicted by Potentia, as shown in FIG. 16 and Table 3 is 13.11 which is closest to the ideal price for players USA and FAHD, which is 13.00. de Mesquita states that the outcome of the Expected Utility Model for this case study is 13.00, which is very close to what is reported by Potentia.

TABLE 3

| | Initial | Round | Round | Round | Round | Round |
|---|---|---|---|---|---|---|
| Players | position | 1 | 2 | 3 | 6 | 16 |
| HAWKS | 14.25 | 14.25 | 14.25 | 14.25 | 14.25 | 13.08 |
| IRAN | 14.20 | 14.20 | 14.20 | 14.20 | 14.19 | 13.11 |
| RUSSIA | 14.20 | 14.20 | 14.20 | 14.21 | 13.02 | 13.03 |
| IPEC | 14.10 | 14.11 | 14.12 | 14.12 | 14.17 | 13.07 |
| GULF | 14.10 | 14.11 | 14.12 | 14.13 | 14.15 | 13.04 |
| MILITARY | 14.00 | 14.03 | 14.04 | 14.07 | 14.10 | 13.04 |
| KUWAIT | 14.00 | 14.02 | 14.03 | 14.05 | 14.08 | 13.06 |
| TRIBALS | 13.95 | 13.98 | 14.00 | 14.01 | 14.05 | 13.07 |
| RELIGIOUS | 13.90 | 13.92 | 13.94 | 13.96 | 14.01 | 13.06 |
| LEADERS | | | | | | |
| BUSINESS | 13.75 | 13.37 | 13.64 | 13.47 | 12.86 | 13.05 |
| SULTAN | 13.40 | 13.36 | 13.29 | 13.47 | 14.06 | 13.11 |
| MAJLIS | 13.35 | 13.27 | 13.24 | 13.50 | 12.85 | 13.08 |
| ABDULLAH | 13.25 | 13.19 | 13.05 | 13.01 | 12.92 | 13.05 |
| FAHD | 13.00 | 12.99 | 12.97 | 12.95 | 13.87 | 13.06 |
| USA | 13.00 | 12.98 | 12.95 | 12.93 | 12.88 | 13.11 |
| NAZER | 12.90 | 12.90 | 12.89 | 12.89 | 12.85 | 13.09 |
| EUR/JPN | 12.85 | 12.85 | 12.85 | 12.85 | 12.85 | 13.06 |
| Median Voter | 13.75 | 13.37 | 13.24 | 13.50 | 12.86 | 13.11 |

### Example 4

### The Years of Introduction of Emission Standards for Medium Sized Automobiles

Example 4 uses data from de Mesquita (1994; Political Forecasting: An Expected Utility Method. In: Stockman, F., Ed., European Community Decision Making, Yale University Press, Yale, Chapter 4, 71-104; incorporated by reference herein). The issue to predict is the number of years that would need to pass before the introduction of emission standards for medium-sized automobiles. The players and their initial capabilities, positions, and salience or priority are illustrated in Table 4. FIGS. 18-20 show the players' positions and the winner position in subsequent rounds.

TABLE 4

| Players | Capability | Position | Salience |
|---|---|---|---|
| Netherlands | 0.08 | 4 | 0.80 |
| Belgium | 0.08 | 7 | 0.40 |
| Luxembourg | 0.03 | 4 | 0.20 |
| Germany | 0.16 | 4 | 0.80 |
| France | 0.16 | 10 | 0.60 |
| Italy | 0.16 | 10 | 0.60 |
| UK | 0.16 | 10 | 0.90 |
| Ireland | 0.05 | 7 | 0.10 |
| Denmark | 0.05 | 4 | 1.00 |
| Greece | 0.08 | 7 | 0.70 |

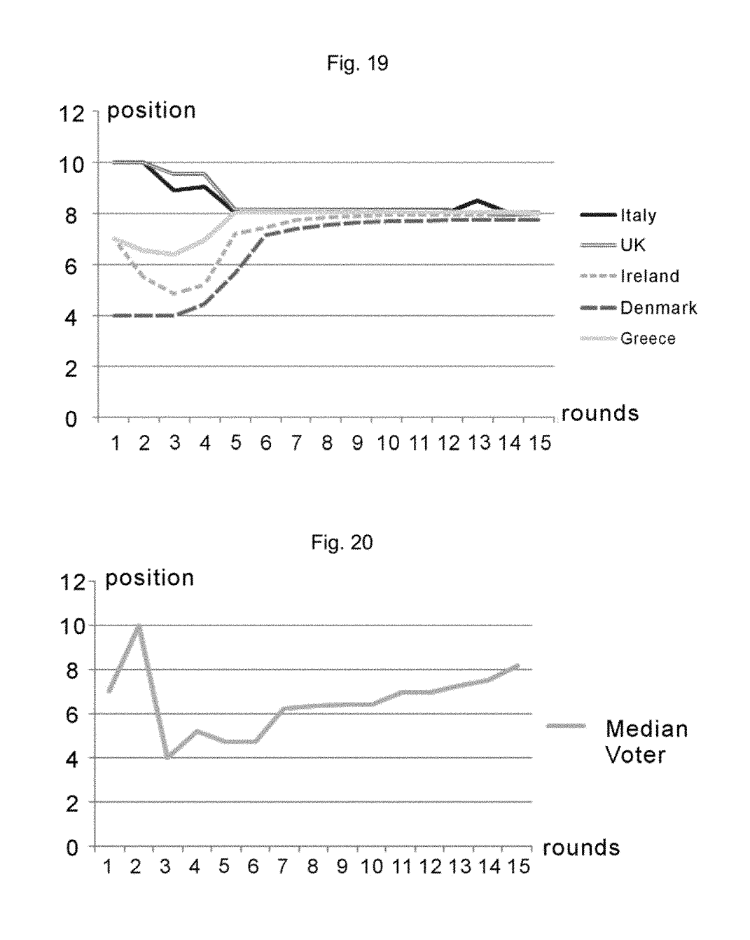

According to de Mesquita, the expected or predicted outcome for this case study is 8.35 years while the actual delay has been 8.83 years. As shown in FIG. 19, Potentia predicts the outcome to be 8.15 years.

### Example 5

### The Winner of Iran's 2013 Election

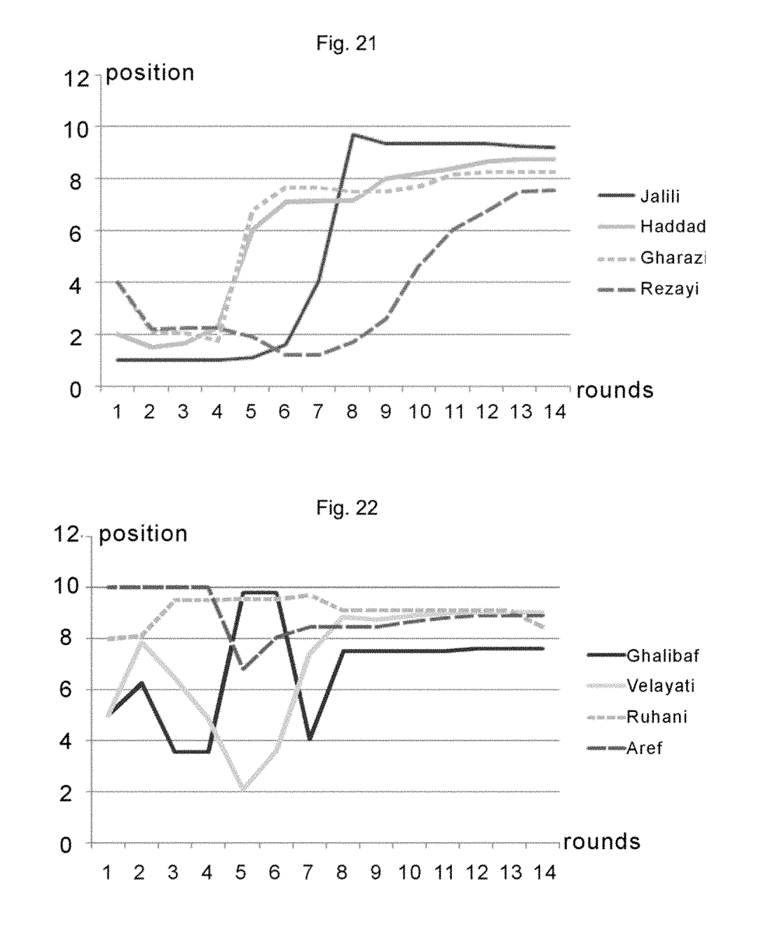

This Example is based on the recent 2013 presidential election in Iran. The input for Potentia is taken from the web-polls before the election and interviews with experts about the initial situation of each candidate before the election. The candidates' positions are determined on a one-dimensional scale of 1-10, the most reformist being on the position 10 and the most fundamentalist being on the position 1. The candidates and their initial capabilities, positions and salience month period before the election are shown in Table 5. FIGS. 21-23 show the players' positions and the winner position in subsequent rounds.

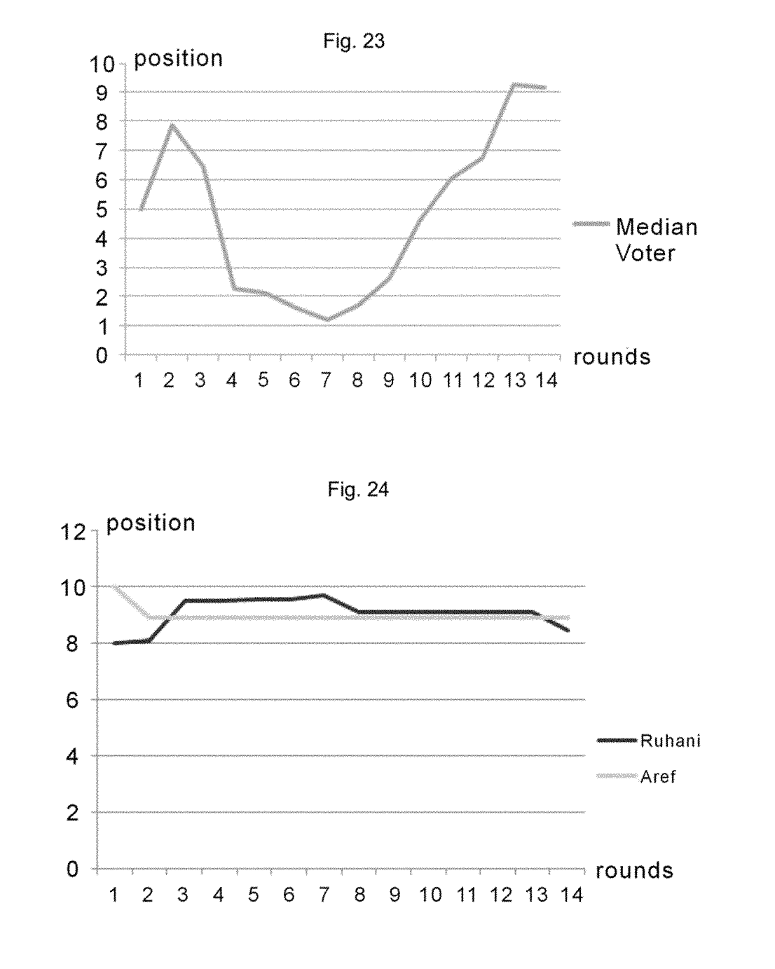

Potentia shows the winner of the election to be position 9.2 which is in the middle of the ideal position for the two reformist candidates Aref and Ruhani. What happened in the actual election is very close to what is shown in FIG. 22. Reformists got stronger and stronger during the debates and right before the election, Ruhani and Aref made a coalition together and Aref left the competition in favor of Ruhani (FIG. 24). Eventually Ruhani won the election. This is more clearly illustrated in FIG. 23.

TABLE 5

| Players | Capability | Position | Salience |
|---|---|---|---|
| Jalili | 0.24 | 1 | 0.70 |
| Haddad | 0.08 | 2 | 1.00 |
| Gharazi | 0.01 | 4 | 1.00 |
| Rezayi | 0.20 | 4 | 0.60 |
| Ghalibaf | 0.64 | 5 | 1.00 |
| Velayati | 0.07 | 5 | 0.25 |
| Ruhani | 0.21 | 8 | 1.00 |
| Aref | 0.30 | 10 | 0.70 |

Various features and advantages of the invention are set forth in the following claims.

What is claimed is:

1. A method for using predictive analytics to support decision-making on an issue, the method comprising:
identifying a plurality of players involved in the issue;
determining, for each of the plurality of players,
a priority of the issue for each player,
a power of each player to influence the issue, and
a position of each player with regard to the issue;
simulating a plurality of rounds of negotiation between each of the plurality of players, wherein each round includes steps of
calculating a median voter position,
calculating an expected utility for each of the plurality of players,
each of the plurality of players receiving a plurality of offers from at least one other player,
each of the plurality of players accepting one of the plurality of offers, and
updating power and position for each of the plurality of players; and
identifying a consensus position and ending the simulation if none of the plurality of players receives an offer.

2. The method of claim 1, wherein identifying a plurality of players comprises steps of
accessing a database comprising information relating to a plurality of events,
filtering the database to identify a first subset of events relating to the issue,
filtering the first subset of events to identify a second subset of events relating to a first side of the issue and a second side of the issue,
identifying a plurality of actors involved in the second subset of events,
determining a number of times each of the plurality of actors is mentioned in the second subset of events and identifying a first group of actors having a greatest number of mentions,
filtering the second subset of events to identify a third subset of events relating to the group of actors having the most mentions,
eliminating irrelevant events from the third subset of events to identify a fourth subset of events, and
determining a number of times each of the first group of actors is mentioned in the fourth subset of events, wherein the plurality of players comprises each of the first group of actors with a greatest number of mentions in the fourth subset of events.

3. The method of claim 1, wherein determining a priority of the issue for each player comprises determining a ratio of the number of times a player has been an initiator of an event related to the issue divided by the maximum number of times any player has been an initiator of an event related to the issue.

4. The method of claim 1, wherein the issue comprises an international conflict, and wherein each of the plurality of players is a country.

5. The method of claim 4, wherein determining a power of each player to influence the issue comprises combining a power index value with a support index value, wherein the power index value is based on one or more of oil production and consumption, military power, labor force, geographical location, and external debt of each player, and wherein the support index value is based on a number of interactions between each of the players and other countries.

6. The method of claim 1, wherein the plurality of rounds comprises 50 rounds.

7. The method of claim 1, further comprising, for each of the plurality of rounds, presenting to a user a wheel and spoke display the position for each of the plurality of players.

8. The method of claim 1, further comprising presenting a round by round timeline display to a user.

9. A computer-based system for using predictive analytics to support decision-making on an issue, the system comprising:
a processor; and
a storage medium operably coupled to the processor, wherein the storage medium includes program instructions executable on the processor for
identifying a plurality of players involved in the issue;
determining, for each of the plurality of players,
a priority of the issue for each player,
a power of each player to influence the issue, and
a position of each player with regard to the issue;
simulating a plurality of rounds of negotiation between each of the plurality of players, wherein each round includes steps of
calculating a median voter position,
calculating an expected utility for each of the plurality of players,
each of the plurality of players receiving a plurality of offers from at least one other player,
each of the plurality of players accepting one of the plurality of offers, and
updating power and position for each of the plurality of players; and
identifying a consensus position and ending the simulation if none of the plurality of players receives an offer.

10. The system of claim 9, wherein program instructions executable on the processor for identifying a plurality of players comprises program instructions for
accessing a database comprising information relating to a plurality of events,
filtering the database to identify a first subset of events relating to the issue,
filtering the first subset of events to identify a second subset of events relating to a first side of the issue and a second side of the issue,
identifying a plurality of actors involved in the second subset of events,
determining a number of times each of the plurality of actors is mentioned in the second subset of events and identifying a first group of actors having a greatest number of mentions,
filtering the second subset of events to identify a third subset of events relating to the group of actors having the most mentions,
eliminating irrelevant events from the third subset of events to identify a fourth subset of events, and
determining a number of times each of the first group of actors is mentioned in the fourth subset of events, wherein the plurality of players comprises each of the first group of actors with a greatest number of mentions in the fourth subset of events.

11. The system of claim 9, wherein program instructions executable on the processor for determining a priority of the issue for each player comprises program instructions for determining a ratio of the number of times a player has been an initiator of an event related to the issue divided by the maximum number of times any player has been an initiator of an event related to the issue.

12. The system of claim 9, wherein the issue comprises an international conflict, and wherein each of the plurality of players is a country.

13. The system of claim 12, wherein program instructions executable on the processor for determining a power of each player to influence the issue comprises program instructions for combining a power index value with a support index value, wherein the power index value is based on one or more of oil production and consumption, military power, labor force, geographical location, and external debt of each player, and wherein the support index value is based on a number of interactions between each of the players and other countries.

14. The system of claim 9, wherein the plurality of rounds comprises 50 rounds.

15. The system of claim 9, wherein the system further comprises a graphical user interface and wherein, for each of the plurality of rounds, the storage medium further comprises program instructions executable on the processor for presenting to a user a wheel and spoke display the position for each of the plurality of players.

16. The system of claim 9, wherein the system further comprises a graphical user interface and wherein the storage medium further comprises program instructions executable on the processor for presenting a round by round timeline display to a user.
